(19) United States
(12) Patent Application Publication
(10) Pub. No.: US 2022/0198961 A1
(43) Pub. Date: Jun. 23, 2022

(54) SYSTEM PARTICULARLY FOR MEDICAL SIMULATION, PARTS FOR SUCH A SYSTEM, CORRESPONDING ASSEMBLY AND METHOD

(71) Applicant: Medability GmbH, Munich (DE)

(72) Inventors: Philipp STEFAN, Munich (DE); Markus ALEXANDRIN, Munich (DE); Felix ACHILLES, Munich (DE); Patrick WUCHERER, Munich (DE); Simon WEIDERT, Munich (DE)

(73) Assignee: Medability GmbH, Munich (DE)

(21) Appl. No.: 17/558,114

(22) Filed: Dec. 21, 2021

(30) Foreign Application Priority Data
Dec. 21, 2020 (DE) 10 2020 134 514.3

(51) Int. Cl. G09B 23/34; G09B 23/28

(52) U.S. Cl. CPC G09B 23/34; G09B 23/286

(57) ABSTRACT

The present invention relates to an insert for a medical simulation system, wherein the insert is configured to be releasably connected to the system, comprising: a connection portion configured to provide the releasable connection to the system, and at least one latching recess, wherein each of the at least one latching recess is configured to receive a latching device of a connection section of the system. The present invention also relates to a medical simulation system, wherein the system is configured to releasably receive an insert, wherein the system comprises a holder assembly configured to provide the releasable connection to the insert, the holder assembly comprising: at least one stopping element, at least one latching element, and at least one latching device. The present invention also relates to a corresponding assembly and to a method.

The present invention relates to a system particularly for medical simulation, parts for such a system, a corresponding assembly and method.

While the invention will be described with primary reference to medical simulation, it will be understood that the invention may also be applicable in other fields. The traditional training process for medical practitioners and surgeons involves practicing medical procedures on cadavers. This presents a host of limitations. The number of cadavers available is limited so the number of procedures that may be practiced is limited, potentially limiting the number of surgeons or practitioners that may be trained. Once a particular procedure has been performed on a cadaver, it may need to be disposed of, regardless of the result of the procedure. Disposing of cadavers has its associated challenges, as has their transport and storage. Another constraint on availability of cadavers comes in the face of procedures specific to certain diseases that may only rarely affect humans and for which thence there is a shortage of cadavers.

Additionally, animal/human skin is opaque so visual feedback in the course of a medical procedure is almost absent. Surgeons and practitioners need to then be guided based on the haptic feedback received from the cadaver. Alternatively, potentially complex equipment with limited availability such as medical imaging equipment, or endoscopy equipment may need to be installed to provide some sort of visual feedback. Use of such complex and not readily available equipment may also preferably be used on real patients as much as possible, which is why for some institutions, it may not be ideal to also use such complex and scarce equipment also for training. Additionally, medical imaging equipment (e.g. fluroscopy/X-ray or CT imaging) may involve exposing trainees and trainers to radiation, which may be sought to be minimized.

In light of these considerations, it is desirable to have a medical simulation system that can allow practitioners to train without the need for cadavers. A possible added benefit of such a simulation system would be to plan and execute a complex procedure in advance of an actual surgery thus minimizing the risk to the patient. It may be advantageous that such a simulation system provides, as far as possible, accurate haptic feedback to the practitioner. It may also be advantageous to allow for performing a large number of simulations of medical procedures easily and quickly. Portability and ease of storage may also be advantageous for such systems.

EP 3355215 A1 discloses a medical simulation system. The present invention relates to aspects that may be added to a medical simulation system, for example the system disclosed in EP 3355215 A1, to draw closer to the goal of cadaver-less medical training. The medical simulation system in EP 3355215 A1 comprises a physical tissue model, i.e. a tangible model of a tissue, that may be based on medical imaging data of real tissue and 3D printed for example, and that may be fitted with sensors that respond to some stimulus. The system may further comprise a stimulus generator such that by detecting this stimulus the position and/or orientation of each of the sensors in the physical tissue model may be determined. The above system may further be augmented by a model of a medical instrument which may also have sensors fitted to it and whose position and/or orientation may also be tracked. Thus, a simulation of a medical procedure may be carried out with the whole procedure being tracked. A virtual model of the physical tissue model and the model instrument may also be provided to enable real-time visual feedback.

The present invention relates to aspects that may be used to further improve the medical simulation system and parts thereof, as well as a corresponding method. However, it should be understood that at least some of the embodiments described herein may also be used in fields different to medical simulation systems.

In a first aspect, the present invention relates to an insert for a system, wherein the insert is configured to be releasably connected to the system.

The system may be a medical simulation system. For example, the system may be configured to simulate a medical procedure. It may be an advantage of such a system that it provides for a realistic simulation of a medical procedure. This may comprise realistic haptic feedback in course of simulation of a medical procedure as well as a visually realistic setup on which the simulation of medical procedure may be carried out.

The insert may comprise a tissue model portion, which may be hard or solid, representing for example, a bone model portion. Alternatively or additionally, it may represent a soft tissue portion, that may be made of polyurethane foam, for example. The tissue model portion may be based on medical imaging data of real tissue from a patient, such as an X-ray, a computer tomography scan, a magnetic resonance imaging scan, or other imaging data.

The insert may be manufactured by an additive manufacturing process such as 3D printing.

This may be a preferred method where the tissue model portion represents a bone model portion.

The insert may also be manufactured by casting or injection. For example, this may be done in embodiments where the tissue model portion may represent soft tissue and so may need to be made with material not suitable to be 3D printed, such as a foaming agent.

The insert may be monolithic or it may comprise multiple pieces. It may be made of one material throughout or may comprise multiple materials.

The insert may comprise a connection portion configured to provide the releasable connection to the system. The connection portion may be a lower end portion of the insert.

The insert may further comprise an outer planar connection surface.

The insert may comprise at least one latching recess, preferably a plurality of latching recesses. For example, the insert may comprise 3 latching recesses or 4 latching recesses.

The insert may further comprise at least one latching recess, configured to receive a latching device of a connection section of the system.

In embodiments the insert may comprise a plurality of latching recesses, e.g., 2 latching recesses, forming a first set of latching recesses.

A plurality of latching recess, e.g., 2 latching recesses, may also form a second set of latching recesses.

Each of the at least one latching recess may comprise a symmetry axis.

Each symmetry axis may be an axis of a right circular cone wherein each of the right circular cones may have an opening angle in the range of 10° to 170°, preferably 30° to 150°, further preferably 60° to 120°. The precise opening angle may determine the force exerted by the latching recess on a latching device that may be received into the latching recess. This force may determine how strongly the insert is held in the system.

Each symmetry axis may be a rotational symmetry axis.

The symmetry axes of the latching recesses may be parallel in the first set of latching recesses.

The symmetry axes of the latching recesses of the second set may not be parallel to the symmetry axes of the latching recesses of the first set and preferably, the symmetry axes of the latching recesses may be parallel in the second set of latching recesses.

The insert that may have a connection portion and an outer planar connection may be configured such that the connection portion may comprise a plurality of contact sections, wherein each contact section may comprise a planar outer contact surface, wherein each planar contact surface may be at an angle to the outer planar connection surface. Each of the angles may be in the range of 0° to 90°, preferably 30° to 60°, further preferably 40° to 50°.

A first contact section of an insert may comprise the first set of latching recesses.

The first set of latching recesses may comprise a first latching recess and a second latching recess. Preferably, the first latching recess may extend inwardly from the planar outer contact surface of the first contact section, and the second latching recess may extend inwardly from a surface, which is set back from the planar outer contact surface of the first contact section. This may allow the insert to be inserted into the system without experiencing significant frictional force from a first latching device that may be encountered when the insert is pushed into the system.

The insert may be configured to be inserted into a holder assembly of the system in an insertion direction. This insertion direction may also serve to define a direction in which significant force may be exerted on the insert in course of simulation of a medical procedure.

The second latching recess of the first set may be more forward in the insertion direction than the first latching recess of the first set.

A second contact section may comprise the second set of latching recesses, wherein the second set of latching recesses may comprise a first latching recess and a second latching recess, wherein the first latching recess may extend inwardly from the planar outer contact surface of the second contact section, and the second latching recess may extend inwardly from a surface, which is set back from the planar outer contact surface of the second contact section, wherein the second latching recess of the second set may be more forward in the insertion direction than the first latching recess of the second set.

The second contact section may be shorter in length along the insertion direction than the first contact section.

The insert may comprise at least one abutment section for abutting at least one abutment mechanism of a holder assembly.

The at least one abutment section may be a plurality of abutment sections.

The at least one abutment section may be located at a forward end of the insert in the insertion direction.

The at least one abutment section may comprise at least one planar abutment surface, wherein the planar abutment surface may be preferably orthogonal to the insertion direction.

The insert may not comprise a magnetic material. That is, in embodiments, the insert may not comprise materials which have a non-zero magnetic susceptibility. This may be advantageous if the system comprises a tracking system that uses magnetic fields.

The insert may comprise at least one channel between the plurality of latching recesses forming the first set of latching recesses that may be parallel to the insertion direction.

The at least one channel may be configured to receive a latching device of the connection system.

The at least one channel may be at least as deep as the first latching recess. This, again, may allow the insert to be inserted into the system without experiencing significant frictional force from a first latching device that may be encountered when the insert is pushed into the system.

The at least one channel may extend from one of the plurality of latching recesses of the first set to another of the plurality of latching recesses of the first set.

The insert may further comprise at least one blocking recess configured to receive at least one blocking element.

The second contact section may be more forward in the insertion direction than the at least one blocking recess.

The second contact section may abut the at least one blocking recess in the insertion direction.

The outer planar connection surface may have an extension along a first direction in the range of 5 mm to 2 m, preferably in the range of 50 mm to 1 m, further preferably in the range of 100 mm to 300 mm and an extension along a second direction, which is perpendicular to the first direction, in the range of 5 mm to 2 m, preferably in the range of 50 mm to 1 m, further preferably in the range of 100 mm to 300 mm.

The insert may have a weight in the range of 1 g to 20 kg, preferably in the range of 10 g to 1 kg, further preferably in the range of 100 g to 500 g.

The insert may comprise a material that has a density in the range of 5 to 2500 kg/m³. For example, it may comprise thermoplastics such as polylactic acid, or polyurethane, plaster of paris, or foaming agents.

The insert may comprise multiple materials wherein each of the multiple materials has a density in the range of 5 to 2500 kg/m³.

Exemplary densities of the materials may be 1210 to 1430 kg/m³ (e.g., in case polylactide acid is used in an additive manufacturing process), 2200 to 2400 kg/m³ (e.g., in case binder jetting is used), 895 to 930 kg/m³ (e.g., in case polypropylene is used), 5 to 90 kg/m³ (e.g., in case a foam, such as polyurethane foam is used), such as around 8 kg/m³ in case of open cell foam, or 1030 to 1070 kg/m³ (e.g., in case acrylonitrile butadiene styrene is used). It should be understood that the material may also be provided with voids, and that the materials may also be combined.

The insert may further comprise a data element configured to at least store data that can be read out. A reading element for reading the data element may be provided on a system configured to be used with the insert, or it may be read by a reading element on any other device. It may also be configured to allow access to the data stored in it only after successful authentication by the reading element.

The data element may be a bar code, such as a QR code.

The data element may be further configured to have computational capability. For example, it may comprise an integrated circuit.

The data element may be further configured for its data to be changed.

The data element may be configured for passive operation, i.e., not requiring energy supply to operate, or it may be configured for active operation. In preferred embodiments, it may be configured for passive operation.

The data element may be a chip configured for wireless communication, such as a Bluetooth or a RFID chip, which may also be referred to as a proximity card.

The insert according to the preceding embodiment, wherein the data element is configured for encrypted communication.

The data element may be configured for symmetrically encrypted communication.

The data element may be configured for asymmetrically encrypted communication.

The data element may be configured for unencrypted communication.

The data element may be an NFC tag.

The communication with the data element may be unencrypted or encrypted. If encrypted, it may be symmetrically encrypted, i.e., a single key may be used for both encryption and decryption of the data. Or it may be asymmetrically encrypted, i.e., different keys may be used for encryption and decryption of the data.

The data element may also be an NFC tag. An advantage of using NFC may be to allow reading of the data element only when the reading element is sufficiently close to the insert. This may be of advantage where more than one insert is present not too distant from the reading element.

The data element may be embedded in the remainder of the insert. For example, in an additive manufacturing process, the insert may be built layer by layer until the position at which the data element needs to be placed is reached, the data element may be embedded into the insert, and further layers may then be added to complete. It should be understood that the data element is thus located in the interior of the insert.

Alternatively, the data element may be located on an outer surface of the insert, for example, in a recess provided on the outer surface of the insert. In preferred embodiments, such a recess may be provided on the underside of the insert.

The data element may comprise an ID. Such an ID may be called a Unique ID or UID in embodiments and may be unique for each data element.

The data element may comprise a key. The key may be a diversified key obtained by using the ID (UID) of the data element and a master key. The data element may further comprise a secure portion. The secure portion of the data element may comprise the key.

In a second aspect, the present invention relates to a system, wherein the system is configured to releasably receive an insert.

The system may be configured to releasably receive an insert according to any of the preceding insert embodiments.

The system may comprise a holder assembly configured to provide the releasable connection to the insert.

The holder assembly may be a single piece or it may comprise multiple pieces. A single piece may be advantageous in guiding an insert into and out of the holder assembly. Multiple pieces may be advantageous in reducing the weight of the holder assembly.

The holder assembly may, at least in part, be manufactured by an additive manufacturing process, such as 3D printing.

The holder assembly may be configured to releasably receive an insert in an insertion direction.

The holder assembly may comprise at least one stopping element. The stopping element may help to support the insert in the insertion direction when force may be applied to the insert during simulation of a medical procedure.

The at least one stopping element may be a plurality of stopping elements. Each of the at least one stopping element may comprise at least one planar surface, wherein the planar surface may be preferably orthogonal to the insertion direction.

Each of the at least one stopping element may be configured to abut the insert in the insertion direction.

The at least one stopping element may comprise at least one damping element. This damping element may serve to provide realistic haptic feedback when force is applied on the insert during simulation of a medical procedure.

The at least one damping element may be a plurality of damping elements.

In embodiments where the at least one stopping element is a plurality of stopping elements, each of the plurality of stopping elements may comprise at least one of a plurality of damping elements.

The at least one damping element may comprise an outer contact surface, wherein the outer contact surface may be configured to abut an insert, when the insert is received in the holder assembly.

Each of the least one damping element may be configured to have an equilibrium configuration and wherein it may be further configured to apply a force in order to return to its equilibrium configuration. For example, the at least one damping element may be connected to a spring.

The equilibrium configuration may comprise the outer contact surface of each of the at least one damping element protruding beyond the planar surface of the stopping element in a direction opposite to the insertion direction.

The holder assembly may further comprise at least one latching element.

The at least one latching element may be a plurality of latching elements.

Each of the at least one latching element may be parallel to the insertion direction.

Each of the at least one latching element may comprise a groove configured to provide the releasable connection to the insert. The groove may help to guide the insert into and out of the holder assembly.

The groove may comprise a basal planar surface. The basal planar surface may be a lower end portion of the groove.

The groove may further comprise a plurality of contact sections wherein each contact section may comprise a planar contact surface. The plurality of contact sections may comprise a first contact section and a second contact section.

The planar contact surface of the first contact section may be orthogonal to the basal planar surface.

The planar contact surface of the second contact section may be at an angle to the planar contact surface of the first contact section, where the angle may be in the range of 90° to 180°, preferably 120° to 150°, further preferably 130° to 140°. This may be chosen to house the contact sections of the insert after the insert has been received. A choice of angle different from 180° may be advantageous in pushing the insert both vertically and horizontally, keeping it stably locked into the system.

The system may further comprise at least one latching device. The at least one latching device may be a plurality of latching devices. For example, it may be 3 latching devices. Preferably, it may be 4 latching devices. The plurality of latching devices may serve to provide a plurality of points at which the insert may be locked into the holder assembly that may provide more stable locking.

Each of the at least one latching device may be configured to have an equilibrium configuration and further configured to apply a force in order to return to its equilibrium configuration. For example, each of the at least one latching device may be connected to a spring.

The at least one latching device may be at least one latching ball or at least one latching pin. The at least one latching pin may have a tapered end. Alternatively, the at least one latching pin may have a rounded end. Further alternatively, the at least one latching pin may have a conical end. The at least one latching pin may not be connected to a spring and may, for example, be moved manually into and out of a latching recess.

The at least one latching device may be located in the second contact sections of a groove of the holder assembly such that the equilibrium configuration may comprise each of the at least one latching device protruding into the groove from the planar contact surface of the second contact section.

Each of the at least one latching device may comprise a symmetry axis.

Each symmetry axis may be a rotational symmetry axis.

A plurality of latching devices, e.g., 2 latching devices, may form a first set of latching devices.

A plurality of latching devices, e.g., 2 latching devices, may form a second set of latching devices.

The symmetry axes of the latching devices may be parallel in the first set of latching devices.

The symmetry axes of the latching devices in the first set may not be parallel to the symmetry axes of the latching devices in the second set and the symmetry axes of the latching devices in the second set may be parallel.

The first set of latching devices may comprise a first latching device and a second latching device, wherein the second latching device in the first set of latching devices may be more forward in the insertion direction than the first latching device.

The second set of latching devices may comprise a first latching device and a second latching device wherein the second latching device in the second set of latching devices may be more forward in the insertion direction than the first latching device.

The second latching device in the first set may protrude deeper into the groove than the first latching device in the first set. This may allow the insert to be pushed through the holder assembly without the first latching device getting locked into the first latching recess.

The second latching device in the second set may protrude deeper into the groove than the first latching device in the second set.

The holder assembly may further comprise at least one blocking element.

The at least one blocking element may be configured to block the holder assembly from receiving the insert.

The at least one blocking element may be configured to block the holder assembly from releasing the insert.

The at least one blocking element may be configured to be immovable parallel to the insertion direction.

The at least one blocking element may be configured to be reversibly placed in a path of reception of the insert.

The at least one blocking element may be configured to have an equilibrium configuration and wherein it may be further configured to apply a force in order to return to its equilibrium configuration. For example, it may be connected to a spring.

The at least one blocking element may be placed in the path of reception of the insert in its equilibrium configuration and be removed from the path of reception of the insert out of its equilibrium configuration. For example, it may be configured such that a part of it blocks the insertion path, with this part being connected via a spring to a base of the holder assembly.

Further, it may be configured to pivot around an axis separating said part from another part.

When the other part of the blocking element is pushed, the part that blocks the insertion path may be pivoted out of the insertion path. On releasing the other part, part of the blocking element may once again block the insertion path.

In embodiments where the holder assembly comprises at least one latching element, one of the at least one latching element may further comprise one of the at least one blocking element.

The holder assembly may further comprise at least one releasing element.

The at least one releasing element may be configured to at least apply a force opposite to the insertion direction.

The at least one releasing element may be configured to expand, at least in part, out of the remainder of the holder assembly and draw, at least in part, into the remainder of the holder assembly.

The at least one releasing element may be configured to have at least one nook.

The at least one nook may be configured to abut the insert in the insertion direction, when the at least one releasing element is in a retracted configuration

The at least one nook may be configured to apply a pushing force on an insert when the at least one releasing element is expanded.

The at least one releasing element may be configured to pivot about a vertical axis, wherein the axis passes through a point not contained in an edge of the releasing element.

The holder assembly may further comprise a base. The base may comprise a lower end portion of the holder assembly.

The base may further comprise at least one calibration marker.

The at least one calibration marker may be configured to enable determination of the position and/or orientation of the holder assembly in space. This may further enable determination of the insert in space.

In embodiments where the holder assembly comprises at least one latching element having a groove with a basal planar surface, the basal planar surface may be contained in the base.

The system may further comprise a soft tissue assembly. This may be of advantage in adding realism to the simulation of a medical procedure.

The soft tissue assembly may be configured to cover, at least in part, the insert.

The soft tissue assembly may further comprise a soft tissue holder. The soft tissue holder may be monolithic. The soft tissue holder may be manufactured using an additive manufacturing process, such as 3D printing. The soft tissue holder may be configured to fit into the holder assembly.

The soft tissue holder may further comprise at least one leg. The at least one leg may be a plurality of legs. For example, it may be 3 legs. Preferably, it may be 4 legs. The soft tissue holder may be shaped like an arc to represent a section of a waist or back on which a simulation of a medical procedure may be carried out. The plurality of legs may then be configured to have different lengths that may enable supporting the soft tissue holder that may have an arc.

Each of the at least one leg may be configured to fit into the holder assembly.

Each of the at least one leg may comprise a symmetry axis.

Each symmetry axis of a leg may be a rotational symmetry axis.

In embodiments with a plurality of legs, each with a symmetry axis, each of a plurality of pairs of symmetry axes is a pair of parallel axes.

A plurality of legs, e.g., 2 legs, may form a first set of legs and each of the plurality of legs in the first set of legs may have the same length.

A plurality of legs, e.g., 2 legs, may form a second set of legs and each of the plurality of legs in the second set of legs may have the same length.

The second set of legs may be more forward in the insertion direction than the first set of legs.

Each of the plurality of legs in the second set of legs may be longer than any of the plurality of legs in the first set of legs.

The soft tissue holder may further comprise a support frame.

The at least one leg may hold up the support frame.

In embodiments with a plurality of legs, each of the plurality of legs may hold up the support frame.

The support frame may comprise an opening that enables the support frame to fit over the insert.

The holder assembly may be further configured to releasably receive the soft tissue holder.

The holder assembly may further comprise at least one support configured for insertion of the at least one leg of the soft tissue holder.

The at least one support hole may be a plurality of support holes. For example, it may be 3 support holes. Preferably, it may be 4 support holes.

Each of the at least one support hole may comprise a symmetry axis. Each symmetry axis may be a rotational symmetry axis.

In embodiments comprising a plurality of support holes, a plurality of symmetry axes may be parallel.

A plurality of support holes, e.g. 2 support holes, may form a first set of support holes.

A plurality of support holes, e.g. 2 support holes, may form a second set of support holes.

The second set of support holes may be more forward in the insertion direction than the first set of support holes.

Each of the second set of support holes may comprise a cylindrical housing and wherein a vertical extension of the support holes in the second set may be greater than a vertical extension of the support holes in the first set.

In embodiments where the holder assembly comprises at least one latching element, the at least one latching element of the holder assembly may comprise the at least one support hole.

Each of the plurality of latching elements of the holder assembly may comprise at least one of the plurality of support holes.

The soft tissue assembly may further comprise a soft tissue portion. This may add further realism to the simulation of a medical procedure.

The soft tissue portion may be a mass of a semi-solid.

The soft tissue portion may comprise, at least in part, any of silicone, a rubber (e.g., unsaturated or saturated), such as natural rubber or latex or chloroprene, polyurethane, a plastic polymer, such as poly vinyl chloride, or an elastomer, e.g., a thermoplastic elastomer, a foaming agent, a coloring agent, an oil, a wax, particles, lubricant additive, or a slip additive.

The soft tissue portion may be a mass of a gel, that may comprise, at least in part, a polymeric gel, or a water-based gel.

The support frame may be further configured to receive the soft tissue portion.

The opening comprising the support frame may be configured to receive the soft tissue portion over the insert.

The soft tissue assembly may further comprise a skin section. The skin section may comprise at least one layer, and preferably a multiple layers, to provide a more realistic model of skin. It may further comprise elements to represent different tissues types, e.g., dermis, hypoderm, fat tissue, nerves, and muscles. In particular, it may comprise different layers of different materials representing such different tissue types

The soft tissue portion may comprise, at least in part, at least a part of, the skin section.

The skin section may be a flexible membrane such that its size in 1 dimension is substantially smaller than its size in the other 2 dimensions.

The flexible membrane may comprise, at least in part, any of silicone, an rubber (e.g., unsaturated or saturated), such as natural rubber or latex or chloroprene, polyurethane, poly vinyl chloride, an elastomer, e.g., a thermoplastic elastomer, or leather.

The flexible membrane may be further configured to be releasably attached to the support frame of the soft tissue holder.

The support frame of the soft tissue holder may be configured to releasably receive the flexible membrane.

The flexible membrane may comprise at least one hole. The at least one hole may be a plurality of holes.

The support frame may further comprise at least one peg. The at least one peg may be a plurality of pegs.

The at least one hole of the skin section may be configured to releasably snap on to the at least one peg.

The system may further comprise a reading element configured to at least read data stored on a data element.

The reading element may be a QR reader.

The reading element may be further configured to effect changes of the data on the data element.

The reading element may be configured for wireless communication, such as communication via Bluetooth or RFID or proximity cards.

The reading element may be an NFC reader.

The system may be configured to be used together with an insert comprising a data element, on which a diversified key obtained from a master key may be stored, wherein the system may comprise the master key, wherein the master key may be preferably stored in a secure section of the system. It may also be stored in a secure section of the reading element, e.g., in a secure section of an NFC reader.

The system may further comprise a data processing means configured to at least store data.

The data processing means may be further configured to effect changes of the data stored in it.

The data processing means may be configured to allow access to data stored in the data processing means based on a key.

The system may be configured to be used together with an insert comprising a data element, on which a diversified key obtained from a master key may be stored, wherein the link to data stored in the data processing means is provided by the diversified key.

The system may be configured to allow only part of the data stored in the data processing means to be accessed using the diversified key.

A tissue model data set may be stored in the data processing means.

The tissue model portion of the insert may correspond to the tissue model data set stored in the data processing means.

The tissue model data set stored in the data processing means may be the data set from a medical image of a real tissue of a patient.

The system may comprise materials that are non-magnetic. That is, the system may not comprise materials having a non-zero magnetic susceptibility.

The system may be configured for encrypted communication.

The system may be configured for symmetrically encrypted communication.

The system may be configured for asymmetrically encrypted communication.

The system may be configured for unencrypted communication.

The system may further comprises a sensor configured to sense a state of the at least one blocking element. Thus, by means of this element (and by potentially also assessing the presence of a data element), it may be detected whether an insert has been pushed into the system in a correct manner.

The system may further comprise a force sensor configured to measure a force acting upon the at least one damping element. Thus, forces acting on the insert may be measured.

In a third aspect, the present invention relates to a reading element. The reading element is configured to at least read data stored on a data element. In this aspect, a reading element may be provided independent from the system. For example, the reading element may be comprised by a smart phone, and this smart phone with the reading element may thus enable a user to read out data of the data element and to manipulate data in the data element, without using the described system.

The reading element may be a QR reader.

The reading element may further be configured to effect changes of the data on the data element.

The reading element may be configured for wireless communication, such as communication via Bluetooth or RFID or proximity cards.

The reading element may be an NFC reader.

The reading element may comprises the master key, wherein the master key is preferably stored in a secure section of the reading element.

The reading element may be configured for encrypted communication.

The reading element may be configured for symmetrically encrypted communication.

The reading element may be configured for asymmetrically encrypted communication.

The reading element may be configured for unencrypted communication.

In a fourth aspect, the present invention also relates to a data processing unit comprising the reading element according to any of the preceding reading element embodiments.

The data processing unit may further comprise a data processing means configured to at least store data.

The data processing means may further be configured to effect changes of the data stored in it.

The data processing means may be configured to allow access to data stored in the data processing means based on a key.

The link to data stored in the data processing means may be provided by the diversified key.

Tata processing unit may be configured to allow only part of the data stored in the data processing means to be accessed using the diversified key.

A tissue model data set may be stored in the data processing means.

The tissue model portion of the insert may correspond to the tissue model data set stored in the data processing means.

The tissue model data set stored in the data processing means may be the data set from a medical image of a real tissue of a patient.

The data processing unit may be a smart phone, a computer, or a tablet.

In a fifth aspect, the present invention relates to an assembly that comprises the system as described above and the insert as described above.

In a sixth aspect, the present invention relates to a method comprising using the assembly according to any of the preceding assembly embodiments.

The method may comprise: the insert being the insert according to any of the preceding insert embodiments, and the system being the system according to any of the preceding system embodiments comprising a holder assembly, wherein the method may further comprise the holder assembly releasably receiving the insert into the system.

The method may comprise: the system being the system comprising a holder assembly configured to receive the insert in an insertion direction, wherein the method may further comprise forcing the insert forward in the insertion direction into the holder assembly to receive the insert into the system, and forcing the insert opposite to the insertion direction out of the holder assembly to release the insert from the system.

The method may comprise: the insert being the insert according to any of the preceding insert embodiments further comprising at least one abutment section and the system being the system comprising a holder assembly configured to receive the insert in an insertion direction, wherein the holder assembly may further comprise at least one damping element, wherein the method may further comprise forcing the insert forward in the insertion direction into the holder assembly until the at least one abutment section of the insert touches the at least one damping element of the holder assembly to receive the insert into the system, and forcing the insert opposite to the insertion direction out of the holder assembly, to release the insert from the system.

The method may comprise: the insert being the insert according to any of the preceding insert embodiments further comprising at least one abutment section and a plurality of latching recesses, and the system being the system comprising a holder assembly configured to receive the insert in an insertion direction, wherein the holder assembly may further comprise at least one damping element and at least one latching device, wherein the method may further comprise forcing the insert forward in the insertion direction into the holder assembly until each of the at least one latching device is received into a respective latching recess and until the at least one abutment section of the insert touches the at least one damping element of the holder assembly to receive an insert into the system, and forcing the insert opposite to the insertion direction out of the holder assembly until each of the at least one latching device is pushed out of the respective latching recess, to release an insert from the system.

The method may comprise: the insert being the insert according to any of the preceding insert embodiments further comprising at least one abutment section, a plurality of latching recesses, and a plurality of contact sections on a connection portion of the insert, and the system being the system comprising a holder assembly configured to receive the insert in an insertion direction, wherein the holder assembly may further comprise at least one damping element, at least one latching device, and a plurality of contact sections of at least one groove, wherein the method may further comprise aligning the plurality of contact sections of the connection portion of the insert with the plurality of contact sections of the groove such that the connection portion of the insert fits into the groove, forcing the insert forward in the insertion direction into the holder assembly until each of the at least one latching device is received into a respective latching recess and until the at least one abutment section of the insert touches the at least one damping element of the holder assembly to receive an insert into the system, and forcing the insert opposite to the insertion direction out of the holder assembly until each of the at least one latching device is pushed out the respective latching recess, to release an insert from the system.

The method may comprise: the insert being the insert according to any of the preceding insert embodiments further comprising at least one abutment section, a plurality of latching recesses, and a plurality of contact sections on a connection portion of the insert, and the system being the system comprising a holder assembly configured to receive the insert in an insertion direction, wherein the holder assembly may further comprise at least one damping element, at least one latching device, a plurality of contact sections of at least one groove, and at least one blocking element, wherein the method may further comprise aligning the plurality of contact sections of the connection portion of the insert with the plurality of contact sections of the groove such that the connection portion of the insert fits into the groove, removing the blocking element from the path of reception of the insert, forcing the insert forward in the insertion direction into the holder assembly until each of the at least one latching device is received into a respective latching recess and until the at least one abutment section of the insert touches the at least one damping element of the holder assembly, and placing the blocking element in the path of reception of the insert, to receive an insert into the system.

The method may further comprise: removing the blocking element from the path of reception of the insert, forcing the insert opposite to the insertion direction out of the holder assembly until each of the at least one latching device is pushed out of the respective latching recess, to release an insert from the system.

The method may further comprise placing the blocking element in the path of reception of the insert after releasing an insert from the system.

The method may comprise: the insert being the insert according to any of the preceding insert embodiments further comprising at least one abutment section, a plurality of latching recesses, and a plurality of contact sections on a connection portion of the insert, and the system being the system comprising a holder assembly configured to receive the insert in an insertion direction, wherein the holder assembly may further comprise at least one damping element, at least one latching device, a plurality of contact sections of at least one groove, at least one blocking element, and at least one releasing element, wherein the method may further comprise: receiving an insert into the system, and removing the blocking element from the path of reception of the insert, operating the releasing element to push the insert opposite to the insertion direction, and further forcing the insert opposite to the insertion direction out of the holder assembly until each of the at least one latching device is pushed out of the respective latching recess, to release the insert from the system.

The method may comprise: the insert being the insert according to any of the preceding insert embodiments, and the system being the system according to any of the preceding system embodiments comprising a soft tissue assembly, wherein the method may further comprise the system releasably receiving the soft tissue assembly.

The method may comprise: receiving an insert into the system, and receiving the soft tissue assembly into the system.

The method may further comprise: releasing the soft tissue assembly from the system, and releasing an insert from the system.

The method may comprise: the insert being the insert according to any of the preceding insert embodiments, and the system being the system according to any of the preceding system embodiments comprising a soft tissue assembly comprising a soft tissue holder that may comprise at least one leg, further comprising a holder assembly that may comprise supporting holes, wherein the method may further comprise: receiving the soft tissue assembly into the system by aligning each of the at least one leg of the soft tissue holder with each of the at least one support hole of the holder assembly, and lowering the soft tissue holder into the at least one support hole, to receive the soft tissue assembly into the system.

The method may further comprise raising the soft tissue holder upwards from the at least one support hole to release the soft tissue assembly from the system.

The method may comprise: the insert being the insert according to any of the preceding insert embodiments further comprising a data element, and the system being the system according to any of the preceding system embodiments further comprising a reading element, wherein the method may comprise the reading element reading data stored on the data element.

The method may further comprise authenticating the data element.

The method may comprise: the insert being the insert according to any of the preceding insert embodiments further comprising a data element that may have an ID and a diversified key stored on it, and the system being the system according to any of the preceding system embodiments that may have a master key stored in it further comprising a reading element, wherein authenticating the data element may comprise the system re-generating the diversified key by means of the master key and the ID, using the re-generated diversified key and the diversified key on the insert for verification.

The method may comprise: the insert being the insert according to any of the preceding insert embodiments further comprising a data element that may have an ID and a diversified key stored on it, and the system being the system according to any of the preceding system embodiments that may have a master key stored in it, comprising a reading element, further comprising a data processing means that may allow access to a part of data stored in it based on the diversified key, wherein the method may further comprise allowing access to the part of data linked to the diversified key stored in the data processing means only when the authentication has been successful.

The method may comprise: the insert being the insert according to any of the preceding insert embodiments further comprising a data element, and the system being the system according to any of the preceding system embodiments further comprising a reading element, wherein the method may comprise the system authenticating the data element and allowing access to the data stored on the data element only when the authentication has been successful.

The method may comprise: the insert being the insert according to any of the preceding insert embodiments further comprising a data element, and the system being a medical simulation system according to any of the preceding system embodiments further comprising a reading element, wherein the method may comprise the system authenticating the data element and allowing a medical simulation only when the authentication has been successful.

The method may comprise changing a counter. The counter may be stored in the data processing means or on the data element. The counter may be changed only when a simulation procedure is detected to have been carried out. The counter may be set to a certain, preferably positive, starting value and changing the counter may comprise decreasing the value of the counter. The counter may be set to zero and changing the counter may comprise increasing the value of the counter. The counter may be configured to have a preset value.

The counter may further not be allowed to change in value after the preset value is reached.

The counter may comprise at least one write-once memory section. The at least one write-once memory section may be a plurality of write-once memory sections. For example, the system may check-off one of the plurality of write-once memory sections, by writing/changing a bit on it for example, for each detection of a successful simulation, and the memory section may not be allowed to be changed after being written on once.

The method may comprise reading and/or changing data comprising anatomical data. For example, anatomical data may comprise details of the anatomy of the real tissue on which the tissue model of the insert is based.

The method may comprise reading and/or changing data comprising physiological data. For example, the physiological data may comprise the medical history of a patient on whose tissue the tissue model of the insert is based.

The method may comprise reading and/or changing data comprising labeling data. For example, labeling data may comprise names/labels of different parts of the tissue/bones in the tissue model of the insert.

The method may comprise reading and/or changing data comprising medical imaging data.

The method may comprise reading and/or changing data comprising treatment data. For example, treatment data may comprise details of any previous medical procedures carried out on the real tissue on which the tissue model of the insert is based.

The method may comprise reading and/or changing planning data. Planning data may by data for a procedure that is planned to be carried out by a medical practitioner.

The method may comprise reading and/or changing data comprising spatial mapping data. For example, spatial mapping data may comprise details of how to map parts of the tissue model of the insert to corresponding parts of a virtual tissue model in a simulation.

The method may comprise reading and/or changing data comprising physical model data. For example, physical model data may comprise details of the material composition of the tissue model of the insert.

The method may comprise reading and/or changing data comprising model usage data. For example, model usage data may comprise details of prior simulations of medical procedures that have been carried out on the tissue model of the current insert, including details of who carried out the simulations and may be an ID of the simulation system used with the insert.

The method may comprise reading and/or changing data comprising logistical data. For example, logistical data can comprise, among other details, any of serial number, batch number, manufacturing date, expiry date, or location of production.

The method may comprise reading and/or changing any of the data as above stored on the data element. Alternatively, it may comprise reading and/or changing any of the data as above stored in a data processing means. An advantage of enabling use of such data may be to provide an additional means to verify the authenticity of the insert, for example, by comparing the anatomical data of the insert with the apparent anatomy of the physical tissue model of the insert.

In a seventh aspect, the present invention relates to the assembly according to any of the preceding assembly embodiments, wherein the assembly is configured to carry out the method according to any of the preceding method embodiments.

In an eighth aspect, the present invention relates to a use of the assembly as described above in a method as described above.

The present invention is also defined by the below numbered embodiments.

In the below, reference will be made to insert embodiments. These embodiments are abbreviated by the letter I followed by a number. Whenever reference is herein made to insert embodiments, these embodiments are meant.

I1. Insert for a system, wherein the insert is configured to be releasably connected to the system.

I2. The insert according to the preceding embodiment, wherein the system is a medical simulation system.

I3. The insert according to any of the preceding embodiments, wherein the insert comprises a tissue model portion.

I4. The insert according to the preceding embodiment, wherein the tissue model portion is a bone model portion.

I5. The insert according to any of the preceding embodiments, wherein the insert is manufactured by an additive manufacturing process.

I6. The insert according to any of the preceding embodiments, wherein the insert is 3D printed.

I7. The insert according to any of the embodiments I1 to I4, wherein the insert is manufactured by casting.

I8. The insert according to any of the embodiments I1 to I4, wherein the insert manufactured by injection.

I9. The insert according to any of the preceding embodiments, wherein the insert is monolithic.

I10. The insert according to any of the preceding embodiments, wherein the insert comprises multiple pieces.

I11. The insert according to any of the preceding embodiments, wherein the insert comprises multiple materials.

I12. The insert according to any of the preceding embodiments, wherein the insert comprises a connection portion configured to provide the releasable connection to the system.

I13. The insert according to the preceding embodiment, wherein the connection portion is a lower end portion of the insert.

I14. The insert according to any of the preceding embodiments, wherein the insert comprises an outer planar connection surface.

I15. The insert according to any of the preceding embodiments, wherein the insert comprises at least one latching recess.

I16. The insert according to the preceding embodiment, wherein the at least one latching recess is a plurality of latching recesses.

I17. The insert according to the preceding embodiment, wherein the at least one latching recess comprises 3 latching recesses.

I18. The insert according to the preceding embodiment, wherein the at least one latching recess comprises 4 latching recesses.

I19. The insert according to any of the preceding embodiments with the features of embodiment I15, wherein each of the at least one latching recess is configured to receive a latching device of a connection section of the system.

I20. The insert according to any of the preceding embodiments with the features of embodiment I16, wherein a plurality of latching recesses, e.g., 2 latching recesses, form a first set of latching recesses.

I21. The insert according to the preceding embodiment, wherein a plurality of latching recess, e.g., 2 latching recesses, form a second set of latching recesses.

I22. The insert according to any of the preceding embodiments with the features of embodiment I15, wherein each of the at least one latching recess comprises a symmetry axis.

I23. The insert according to the preceding embodiment, wherein each symmetry axis is an axis of a right circular cone.

I24. The insert according to the preceding embodiment, wherein each of the right circular cones has an opening angle in the range of 10° to 170°, preferably 30° to 150°, further preferably 60° to 120°.

I25. The insert according to any of the preceding embodiments with the features of embodiment I22, wherein each symmetry axis is a rotational symmetry axis.

I26. The insert according to any of the preceding embodiments with the features of embodiments I20 and 122,
wherein the symmetry axes of the latching recesses are parallel in the first set of latching recesses.

I27. The insert according to the preceding embodiment and with the features of embodiment I21,
wherein the symmetry axes of the latching recesses of the second set are not parallel to the symmetry axes of the latching recesses of the first set and wherein preferably, the symmetry axes of the latching recesses are parallel in the second set of latching recesses.

I28. The insert according to any of the preceding embodiments with the features of embodiments I12 and 114,
wherein the connection portion comprises a plurality of contact sections, wherein each contact section comprises a planar outer contact surface, wherein each planar contact surface is at an angle to the outer planar connection surface.

I29. The insert according to the preceding embodiment, wherein each of the angles is in the range of 0° to 90°, preferably 30° to 60° further preferably 40° to 50°.

I30. The insert according to any of the preceding embodiments with the features of embodiments I20 and 128,
wherein a first contact section comprises the first set of latching recesses.

I31. The insert according to the preceding embodiment, wherein
the first set of latching recesses comprises a first latching recess and a second latching recess; wherein preferably the first latching recess extends inwardly from the planar outer contact surface of the first contact section, and the second latching recess extends inwardly from a surface, which is set back from the planar outer contact surface of the first contact section.

I32. The insert according to any of the preceding embodiments, wherein the insert is configured to be inserted into a holder assembly of the system in an insertion direction.

I33. The insert according to the preceding embodiment and with the features of the penultimate embodiment, wherein the second latching recess of the first set is more forward in the insertion direction than the first latching recess of the first set.

I34. The insert according to the preceding embodiment and with the features of embodiments I21 and 128,
wherein a second contact section comprises the second set of latching recesses,
wherein the second set of latching recesses comprises a first latching recess and a second latching recess, wherein the first latching recess extends inwardly from the planar outer contact surface of the second contact section, and the second latching recess extends inwardly from a surface, which is set back from the planar outer contact surface of the second contact section, wherein the second latching recess of the second set is more forward in the insertion direction than the first latching recess of the second set.

I35. The insert according to any of the preceding embodiments with the features of embodiments I28, 130, 132, and 134, wherein the second contact section is shorter in length along the insertion direction than the first contact section.

I36. The insert according to any of the preceding embodiments with the features of embodiment I32,
wherein the insert comprises at least one abutment section for abutting at least one abutment mechanism of a holder assembly.

I37. The insert according to the preceding embodiment, wherein the at least one abutment section is a plurality of abutment sections.

I38. The insert according to any of the preceding embodiments with the features of embodiment I36, wherein the at least one abutment section is located at a forward end of the insert in the insertion direction.

I39. The insert according to any of the preceding embodiments with the features of embodiment I36, wherein the at least one abutment section comprises at least one planar abutment surface, wherein the planar abutment surface is preferably orthogonal to the insertion direction.

I40. The insert according to any of the preceding embodiments, wherein the insert does not comprise a magnetic material.

That is, in embodiments, the insert may not comprise materials which have a non-zero magnetic susceptibility.

I41. The insert according to any of the preceding embodiments with the features of embodiment I20, wherein the insert comprises at least one channel between the plurality of latching recesses forming the first set of latching recesses.

I42. The insert according to the preceding embodiment and with the features of embodiment I32, wherein the at least one channel is parallel to the insertion direction.

I43. The insert according to any of the 2 preceding embodiments, wherein the at least one channel is configured to receive a latching device of the connection system.

I44. The insert according to any of the 3 preceding embodiments with the features of embodiment I31, wherein the at least one channel is at least as deep as the first latching recess.

I45. The insert according to any of the 4 preceding embodiments, wherein the channel extends from one of the plurality of latching recesses of the first set to another of the plurality of latching recesses of the first set.

I46. The insert according to any of the preceding embodiments, wherein the insert comprises at least one blocking recess configured to receive at least one blocking element.

I47. The insert according to the preceding embodiment and with the features of the embodiments I34, wherein the second contact section is more forward in the insertion direction than the at least one blocking recess.

I48. The insert according to the preceding embodiment, wherein the second contact section abuts the at least one blocking recess in the insertion direction.

I49. The insert according to any of the preceding embodiments with the features of embodiment I14, wherein the outer planar connection surface has an extension along a first direction in the range of 5 mm to 2 m, preferably in the range of 50 mm to 1 m, further preferably in the range of 100 mm to 300 mm and an extension along a second direction, which is perpendicular to the first direction, in the range of 5 mm to 2 m, preferably in the range of 50 mm to 1 m, further preferably in the range of 100 mm to 300 mm.

I50. The insert according to any of the preceding embodiments, wherein the insert has a weight in the range of 1 g to 20 kg, preferably in the range of 10 g to 1 kg, further preferably in the range of 100 g to 500 g.

I51. The insert according to any of the preceding embodiments, wherein the insert comprises a material that has a density in the range of 5 to 2500 kg/m³.

I52. The insert according to any of the preceding embodiments with the features of embodiment I11, wherein each of the multiple materials has a density in the range of 5 to 2500 kg/m³.

I53. The insert according to any of the preceding embodiments, wherein the insert further comprises a data element configured to at least store data that can be read out.

I54. The insert according to the preceding embodiment, wherein the data element is a bar code, such as a QR code.

I55. The insert according to the penultimate embodiment, wherein the data element is configured to have computational capability.

For example, it may comprise an integrated circuit.

I56. The insert according to any of the preceding embodiments with the features of embodiment I53, wherein the data element is further configured for its data to be changed.

I57. The insert according to any of the preceding embodiments with the features of embodiment I53, wherein the data element is a chip configured for wireless communication, such as a Bluetooth or a RFID chip or a proximity card.

I58. The insert according to the preceding embodiment, wherein the data element is configured for encrypted communication.

I59. The insert according to the preceding embodiment, wherein the data element is configured for symmetrically encrypted communication.

I60. The insert according to any of the preceding embodiments with the features of the penultimate embodiment, wherein the data element is configured for asymmetrically encrypted communication.

I61. The insert according to any of the preceding embodiments with the features of embodiment I57, wherein the data element is configured for unencrypted communication.

I62. The insert according to any of the preceding embodiments with the features of embodiment I57, wherein the data element is an NFC tag.

I63. The insert according to any of the preceding embodiments with the features of embodiment I53, wherein the data element is embedded in the remainder of the insert.

I64. The insert according to any of the preceding embodiments with the features of embodiment I53, and without the features of the preceding embodiment, wherein the data element is located on an outer surface of the insert.

I65. The insert according to any of the preceding embodiments with the features of embodiment I53, wherein the data element comprises an ID.

I66. The insert according to any of the preceding embodiments with the features of embodiment I53, wherein the data element comprises a key.

I67. The insert according to the preceding embodiment and with the features of the penultimate embodiment, wherein the key is a diversified key obtained by using the ID of the data element and a master key.

I68. The insert according to any of the preceding embodiments with the features of embodiment I53, wherein the data element comprises a secure portion.

I69. The insert according to any of the preceding embodiment with the features of embodiments I66 and 168, wherein the secure portion comprises the key.

In the below, reference will be made to system embodiments. These embodiments are abbreviated by the letter S followed by a number. Whenever reference is herein made to system embodiments, these embodiments are meant.

S1. System, wherein the system is configured to releasably receive an insert.

S2. The system according to the preceding embodiment, wherein the system is configured to releasably receive an insert according to any of the preceding insert embodiments.

S3. The system according to any of the preceding system embodiments, wherein the system is a medical simulation system.

S4. The system according to any of the preceding system embodiments, wherein the system comprises a holder assembly configured to provide the releasable connection to the insert.

S5. The system according to the preceding embodiment, wherein the holder assembly is a single piece.

S6. The system according to the penultimate embodiment, wherein the holder assembly comprises multiple pieces.

S7. The system according to any of the preceding system embodiments with the features of embodiment S4, wherein the holder assembly is 3D printed.

S8. The system according to any of the preceding system embodiments with the features of embodiment S4, wherein the holder assembly is configured to releasably receive an insert with the features of the insert embodiment I32.

S9. The system according to any of the preceding system embodiments with the features of embodiment S4, wherein the holder assembly comprises at least one stopping element.

S10. The system according to the preceding embodiment, wherein the at least one stopping element is a plurality of stopping elements.

S11. The system according to any of the 2 preceding embodiments and with the features of embodiment S8, wherein each of the at least one stopping element comprises at least one planar surface, wherein the planar surface is preferably orthogonal to the insertion direction.

S12. The system according to the preceding embodiment, wherein each of the at least one stopping element is configured to abut the insert in the insertion direction.

S13. The system according to any of the preceding system embodiments with the features of embodiment S9, wherein the at least one stopping element comprises at least one damping element.

S14. The system according to the preceding embodiment, wherein the at least one damping element is a plurality of damping elements.

S15. The system according to the preceding embodiment and with the features of embodiment S10, wherein each of the plurality of stopping elements comprises at least one of the plurality of damping elements.

S16. The system according to any of the preceding system embodiments and with the features of embodiment S13, wherein each of the at least one damping element comprises an outer contact surface, wherein the outer contact surface is configured to abut an insert, when the insert is received in the holder assembly.

S17. The system according to the any of the preceding system embodiments with the features of embodiment S13, wherein each of the least one damping element is configured to have an equilibrium configuration and wherein it is further configured to apply a force in order to return to its equilibrium configuration.

S18. The system according to the preceding embodiment and with the features of embodiment S11, wherein the equilibrium configuration comprises the outer contact surface of each of the at least one damping element protruding beyond the planar surface of the stopping element in a direction opposite to the insertion direction.

S19. The system according to the preceding embodiment, wherein each of the at least one damping element is connected to a spring.

S20. The system according to any of the preceding system embodiments and with the features of embodiment S4, wherein the holder assembly comprises at least one latching element.

S21. The system according to the preceding embodiment, wherein the at least one latching element is a plurality of latching elements.

S22. The system according to any of the 2 preceding embodiments and with the features of embodiment S8, wherein each of the at least one latching element is parallel to the insertion direction.

S23. The system according to any of the 3 preceding embodiments, wherein each of the at least one latching element comprises a groove configured to provide the releasable connection to the insert.

S24. The system according to the preceding embodiment, wherein the groove comprises a basal planar surface.

S25. The system according to the preceding embodiment, wherein the basal planar surface is a lower end portion of the groove.

S26. The system according to any of the preceding system embodiments with the features of embodiment S23, wherein the groove comprises a plurality of contact sections wherein each contact section comprises a planar contact surface.

S27. The system according to the preceding embodiment, wherein the plurality of contact sections comprises a first contact section and a second contact section.

S28. The system according to any of the preceding embodiments and with the features of embodiments S24 and S27, wherein the planar contact surface of the first contact section is orthogonal to the basal planar surface.

S29. The system according to the penultimate embodiment, wherein the planar contact surface of the second contact section is at an angle to the planar contact surface of the first contact section.

S30. The system according to the preceding embodiment, wherein the angle is in the range of 90° to 180°, preferably 120° to 150°, further preferably 130° to 140°.

S31. The system according to any of the preceding system embodiments, wherein the system comprises at least one latching device.

S32. The system according to the preceding embodiment, wherein the at least one latching device is at least one latching ball.

S33. The system according to the penultimate embodiment, wherein the at least one latching device is at least one latching pin.

S34. The system according to the preceding embodiment, wherein the at least one latching pin has a tapered end or a conical end.

S35. The system according to the penultimate embodiment, wherein the at least one latching pin has a rounded end.

S36. The system according to any of the preceding system embodiments with the features of embodiment S31, wherein the at least one latching device is a plurality of latching devices.

S37. The system according to the preceding embodiment, wherein the at least one latching device comprises 3 latching devices.

S38. The system according to the preceding embodiment, wherein the at least one latching device comprises 4 latching devices.

S39. The system according to any of the preceding system embodiments and with the features of embodiment S31, wherein each of the at least one latching device is configured to have an equilibrium configuration and wherein it is further configured to apply a force in order to return to its equilibrium configuration.

S40. The system according to the preceding embodiment and with the features of embodiment S27, wherein the at least one latching device is located in the second contact section of the groove and wherein the equilibrium configuration comprises each of the at least one latching device protruding into the groove from the planar contact surface of the second contact section.

S41. The system according to any of the 2 preceding embodiments, wherein each of the at least one latching device is connected to a spring.

S42. The system according to any of the preceding system embodiments with the features of embodiment S36, wherein a plurality of latching devices, e.g., 2 latching devices, form a first set of latching devices.

S43. The system according to the preceding embodiment, wherein a plurality of latching devices, e.g., 2 latching devices, form a second set of latching devices.

S44. The system according to any of the preceding system embodiments with the features of embodiment S32, wherein each of the at least one latching device comprises a symmetry axis.

S45. The system according to the preceding embodiment, wherein each symmetry axis is a rotational symmetry axis.

S46. The system according to any of the preceding system embodiments with the features of embodiments S42 and S44,
wherein the symmetry axes of the latching devices are parallel in the first set of latching devices.

S47. The system according to the preceding embodiment and with the features of embodiment S43,
wherein the symmetry axes of the latching devices in the first set are not parallel to the symmetry axes of the latching devices in the second set and wherein the symmetry axes of the latching devices in the second set are parallel.

S48. The system according to any of the preceding system embodiments with the features of embodiments S8 and S42,
wherein the first set of latching devices comprises a first latching device and a second latching device, wherein the second latching device in the first set of latching devices is more forward in the insertion direction than the first latching device.

S49. The system according to any of the preceding system embodiments with the features of embodiments S8 and S43,
wherein the second set of latching devices comprises a first latching device and a second latching device wherein the second latching device in the second set of latching devices is more forward in the insertion direction than the first latching device.

S50. The system according to any of the preceding system embodiments with the features of the penultimate embodiment and with the features of embodiment S40, wherein the second latching device in the first set protrudes deeper into the groove than the first latching device in the first set.

S51. The system according to any of the preceding system embodiments with the features of the penultimate embodiment and with the features of embodiment S40, wherein the second latching device in the second set protrudes deeper into the groove than the first latching device in the second set.

S52. The system according to any of the preceding system embodiments with the features of embodiment S4, wherein the holder assembly comprises at least one blocking element.

S53. The system according to the preceding embodiment, wherein the at least one blocking element is configured to block the holder assembly from receiving the insert.

S54. The system according to any of the 2 preceding embodiments, wherein the at least one blocking element is configured to block the holder assembly from releasing the insert S55. The system according to any of the preceding system embodiments with the features of embodiments S8 and S52, wherein the at least one blocking element is configured to be immovable parallel to the insertion direction.

S56. The system according to the preceding embodiment, wherein the at least one blocking element is configured to be reversibly placed in a path of reception of the insert.

S57. The system according to any of the preceding system embodiment with the features of embodiment S52, wherein the at least one blocking element is configured to have an equilibrium configuration and wherein it is further configured to apply a force in order to return to its equilibrium configuration.

S58. The system according to the preceding embodiment and with the features of the penultimate embodiment, wherein the at least one blocking element is placed in the path of reception of the insert in its equilibrium configuration.

S59. The system according to any of the preceding system embodiments with the features of embodiment S52, wherein the at least one blocking element is connected to a spring.

S60. The system according to any of the 8 preceding embodiments with the features of embodiment S20, wherein one of the at least one latching element further comprises one of the at least one blocking element.

S61. The system according to any of the preceding system embodiments with the features of embodiment S4, wherein the holder assembly comprises at least one releasing element.

S62. The system according to the preceding embodiment with the features of embodiment 88, wherein the at least one releasing element is configured to at least apply a force opposite to the insertion direction.

S63. The system according to any of the 2 preceding embodiments, wherein the at least one releasing element is configured to expand, at least in part, out of the remainder of the holder assembly and draw, at least in part, into the remainder of the holder assembly.

S64. The system according to any of the preceding system embodiments with the features of embodiment S61, wherein the at least one releasing element is configured to have at least one nook.

S65. The system according to the preceding embodiment and with the features of embodiment S8, wherein the at least one nook is configured to abut the insert in the insertion direction, when the at least one releasing element is in a retracted configuration

S66. The system according to the preceding embodiment, wherein the at least one nook is configured to apply a pushing force on an insert when the at least one releasing element is expanded.

S67. The system according to any of the 6 preceding embodiments, wherein the at least one releasing element is configured to pivot about a vertical axis, wherein the axis passes through a point not contained in an edge of the releasing element.

S68. The system according to any of the system preceding embodiments with the features of embodiment S4, wherein the holder assembly comprises a base.

S69. The system according to the preceding embodiment, wherein the base comprises a lower end portion of the holder assembly.

S70. The system according to the preceding embodiment, wherein the base further comprises at least one calibration marker.

S71. The system according to the preceding embodiment, wherein the at least one calibration marker is configured to enable determination of the position and/or orientation of the holder assembly in space.

S72. The system according to any of the preceding system embodiments with the features of embodiments S24 and S68, wherein the base comprises the basal planar surface.

S73. The system according to any of the preceding system embodiments, wherein the system comprises a soft tissue assembly.

S74. The system according to the preceding embodiment, wherein the soft tissue assembly is configured to cover, at least in part, the insert.

S75. The system according to any of the preceding system embodiments with the features of embodiment S73, wherein the soft tissue assembly comprises a soft tissue holder.

S76. The system according to the preceding embodiment, wherein the soft tissue holder is monolithic.

S77. The system according to any of the preceding system embodiments with the features of the penultimate embodiment, wherein the soft tissue holder is manufactured by an additive manufacturing process such as 3D printing.

S78. The system according to any of the preceding system embodiments with the features of embodiments S4 and S75, wherein the soft tissue holder is configured to fit into the holder assembly.

S79. The system according to any of the preceding system embodiments with the features of embodiment S75, wherein the soft tissue holder comprises at least one leg.

S80. The system according to the preceding embodiment, wherein the at least one leg is a plurality of legs.

S81. The system according to the preceding embodiment, wherein the at least one legs comprises 3 legs.

S82. The system according to the preceding embodiment, wherein the at least one leg comprises 4 legs.

S83. The system according to any of the preceding system embodiments with the features of embodiments S4 and S79, wherein each of the at least one leg is configured to fit into the holder assembly.

S84. The system according to any of the 4 preceding embodiments, wherein each of the at least one leg comprises a symmetry axis.

S85. The system according to the preceding embodiment, wherein each symmetry axis of a leg is a rotational symmetry axis.

S86. The system according to the preceding embodiment and with the features of embodiment S80, wherein each of a plurality of pairs of symmetry axes is a pair of parallel axes.

S87. The system according to any of the preceding system embodiments with the features of embodiment S80, wherein a plurality of legs, e.g. 2 legs, form a first set of legs and, wherein each of the plurality of legs in the first set of legs has the same length.

S88. The system according to the preceding embodiment, wherein a plurality of legs, e.g. 2 legs, form a second set of legs and, wherein each of the plurality of legs in the second set of legs has the same length.

S89. The system according to the 2 preceding embodiments, wherein the system is configured to receive an insert according to the insert embodiment I32 and
wherein the second set of legs is more forward in the insertion direction than the first set of legs.

S90. The system according to the preceding embodiment, wherein each of the plurality of legs in the second set of legs is longer than any of the plurality of legs in the first set of legs.

S91. The system according to any of the preceding system embodiments with the features of embodiment S75, wherein the soft tissue holder comprises a support frame.

S92. The system according to the preceding embodiment with the features of embodiment S79, wherein the at least one leg holds up the support frame.

S93. The system according to the penultimate embodiment with the features of embodiment S80, wherein each of the plurality of legs holds up the support frame.

S94. The system according to any of the preceding system embodiments with the features of embodiment S91, wherein the support frame comprises an opening that enables the support frame to fit over the insert.

S95. The system according to any of the preceding system embodiments with the features of embodiments S4 and S79, wherein the holder assembly is configured to releasably receive the soft tissue holder.

S96. The system according to any of the preceding system embodiments with the features of embodiment S79, wherein the holder assembly comprises at least one support hole configured for insertion of the at least one leg of the soft tissue holder.

S97. The system according to the preceding embodiment, wherein the at least one support hole is a plurality of support holes.

S98. The system according to the preceding embodiment, wherein the at least one support hole comprises 3 support holes.

S99. The system according to the preceding embodiment, wherein the at least one support hole comprises 4 support holes.

S100. The system according to any of the preceding system embodiments with the features of embodiment S97, wherein each of the at least one support hole comprises a symmetry axis.

S101. The system according to the preceding embodiment, wherein each symmetry axis is a rotational symmetry axis.

S102. The system according to the preceding embodiment and with the features of embodiment S97, wherein the symmetry axes of each of a plurality of support holes is parallel.

S103. The system according to any of the preceding system embodiments with the features of embodiment S97, wherein a plurality of support holes, e.g. 2 support holes, form a first set of support holes.

S104. The system according to the preceding embodiment, wherein a plurality of support holes, e.g. 2 support holes, form a second set of support holes.

S105. The system according to the preceding embodiment with the features of embodiment S8, wherein the second set of support holes is more forward in the insertion direction than the first set of support holes.

S106. The system according to the preceding embodiment, wherein each of the second set of support holes comprises a cylindrical housing and wherein a vertical extension of the support holes in the second set is greater than a vertical extension of the support holes in the first set.

S107. The system according to any of the preceding system embodiments with the features of embodiments S20 and S96, wherein the at least one latching element comprises the at least one support hole.

S108. The system according to the penultimate embodiment and with the features of embodiments S21 and S97, wherein each of the plurality of latching elements comprises at least one of the plurality of support holes.

S109. The system according to any of the preceding system embodiments with the features of embodiment S73, wherein the soft tissue assembly comprises a soft tissue portion.

S110. The system according to the preceding embodiment, wherein the soft tissue portion is a mass of a semi-solid.

S111. The system according to any of the preceding system embodiments with the features of embodiment S109, wherein the soft tissue portion comprises a foaming agent.

S112. The system according to any of the preceding system embodiments with the features of embodiment S109, wherein the soft tissue portion comprises a coloring agent.

S113. The system according to any of the preceding system embodiments with the features of embodiment 5109, wherein the soft tissue portion comprises a plastic polymer, such as poly vinyl chloride.

S114. The system according to any of the preceding system embodiments with the features of embodiment S109, wherein the soft tissue portion comprises an oil S115. The system according to any of the preceding system embodiments with the features of embodiment S109, wherein the soft tissue portion comprises a wax.

S116. The system according to any of the preceding system embodiments with the features of embodiment S109, wherein the soft tissue portion comprises a softener.

S117. The system according to any of the preceding system embodiments with the features of embodiment S109, wherein the soft tissue portion comprises a fabric.

S118. The system according to any of the preceding system embodiments with the features of embodiment S109, wherein the soft tissue portion comprises silicone, a rubber (e.g., unsaturated or saturated), such as natural rubber or latex or chloroprene, polyurethane, or an elastomer, e.g., a thermoplastic elastomer.

S119. The system according to any of the preceding system embodiments with the features of embodiment S109, wherein the soft tissue portion comprises a lubricant additive, or a slip additive.

S120. The system according to the any of the preceding system embodiment with the features of embodiment S109, wherein the soft tissue portion is a mass of a gel.

S121. The system according to any of the preceding system embodiments with the features of embodiment S109, wherein the soft tissue portion is a mass, at least in part, of a polymeric gel.

S122. The system according to any of the preceding system embodiments with the features of embodiment 5109, wherein the soft tissue portion is a mass, at least in part, of a water-based gel.

S123. The system according to any of the preceding system embodiments with the features of embodiments 591 and 5109, wherein the support frame is configured to receive the soft tissue portion.

S124. The system according to the preceding embodiment and with the features of embodiment 594, wherein the opening comprising the support frame is configured to receive the soft tissue portion over the insert.

S125. The system according to any of the preceding system embodiments with the features of embodiment 573, wherein the soft tissue assembly comprises a skin section.

S126. The system according to any of the preceding system embodiments with the features of embodiments S109 and 5125, wherein the soft tissue portion comprises the skin section.

S127. The system according to any of the preceding embodiments with the features of the penultimate embodiment, wherein the skin section comprises at least one layer.

S128. The system according to the preceding embodiment, wherein the at least one layer is a plurality of layers.

S129. The system according to any of the preceding system embodiments with the features of embodiment 5125, wherein the skin section further comprises elements representative of different tissue types.

S130. The system according to any of the preceding system embodiments with the features of embodiment 5125, wherein the skin section is a flexible membrane such that its size in 1 dimension is substantially smaller than its size in the other 2 dimensions.

S131. The system according to the preceding embodiment, wherein the flexible membrane is made of silicone.

S132. The system according to any of the preceding system embodiments with the features of embodiment S130, wherein the flexible membrane comprises a rubber (e.g., unsaturated or saturated), such as natural rubber or latex or chloroprene.

S133. The system according to any of the preceding system embodiments with the features of embodiment S130, wherein the flexible membrane comprises polyurethane.

S134. The system according to any of the preceding system embodiments with the features of embodiment S130, wherein the flexible membrane comprises poly vinyl chloride.

S135. The system according to any of the preceding system embodiments with the features of embodiment S130, wherein the flexible membrane comprises an elastomer.

S136. The system according to the preceding embodiment, wherein the elastomer is a thermoplastic elastomer.

S137. The system according to any of the preceding system embodiments with the features of embodiment S130, wherein the flexible membrane comprises leather.

S138. The system according to any of the preceding system embodiments with the features of embodiment S91 and S130, wherein the flexible membrane is configured to be releasably attached to the support frame of the soft tissue holder.

S139. The system according to the preceding embodiment, wherein the support frame of the soft tissue holder is configured to releasably receive the flexible membrane.

S140. The system according to the penultimate embodiment, wherein the flexible membrane comprises at least one hole.

S141. The system according to the preceding embodiment, wherein the at least one hole is a plurality of holes.

S142. The system according to any of the preceding system embodiments with the features of embodiment S139, wherein the support frame comprises at least one peg.

S143. The system according to the preceding embodiment, wherein the at least one peg is a plurality of pegs.

S144. The system according to any of the preceding system embodiments with the features of embodiments S140 and S142, wherein the at least one hole is configured to releasably snap on to the at least one peg.

S145. The system according to any of the preceding system embodiments, wherein the system comprises a reading element configured to at least read data stored on a data element.

S146. The system according to the preceding embodiment, wherein the reading element is a QR reader.

S147. The system according to any of the preceding system embodiments with the features of the penultimate embodiment, wherein the reading element is further configured to effect changes of the data on the data element.

S148. The system according to any of the preceding system embodiments with the features of embodiment S145 and without the features of embodiment S101, wherein the reading element is configured for wireless communication, such as communication via Bluetooth or RFID or proximity cards.

S149. The system according to any of the preceding system embodiments with the features of embodiment S145 and without the features of embodiment S146, wherein the reading element is an NFC reader.

S150. The system according to any of the preceding system embodiments with the features of embodiment S145, wherein the system is configured to be used together with an insert comprising the features of embodiment I67, wherein the system comprises the master key, wherein the master key is preferably stored in a secure section of the system.

S151. The system according to any of the preceding system embodiments, wherein the system further comprises a data processing means configured to at least store data.

S152. The system according to the preceding embodiment, wherein the data processing means is further configured to effect changes of the data stored in it.

S153. The system according to any of the two preceding embodiments, wherein the data processing means is configured to allow access to data stored in the data processing means based on a key.

S154. The system according to the preceding embodiment, wherein the system is configured to be used together with an insert comprising the features of embodiment I67, wherein the link to data stored in the data processing means is provided by the diversified key.

S155. The system according to the preceding embodiment, wherein the system is configured to allow only part of the data stored in the data processing means to be accessed using the diversified key.

S156. The system according to any of the preceding system embodiments, wherein the system comprises materials that are non-magnetic.

That is, the system may not comprise materials having a non-zero magnetic susceptibility.

S157. The system according to any of the preceding system embodiments with the features of embodiments S3 and S151, wherein a tissue model data set is stored in the data processing means.

S158. The system according to the preceding embodiment, wherein the system is configured to be used together with an insert according to the insert embodiment I3, wherein the tissue model portion of the insert corresponds to the tissue model data set stored in the data processing means.

S159. The system according to any of the 2 preceding embodiments, wherein the tissue model data set stored in the data processing means is the data set from a medical image of a real tissue of a patient.

S160. The system according to any of the preceding system embodiments with the features of embodiment S148, wherein the system is configured for encrypted communication.

S161. The system according to the preceding embodiments, wherein the system is configured for symmetrically encrypted communication.

S162. The system according to any of the 2 preceding embodiments, wherein the system is configured for asymmetrically encrypted communication.

S163. The system according to any of the preceding system embodiments with the features of embodiments S148, wherein the system is configured for unencrypted communication.

S164. The system according to any of the preceding system embodiments with the features of embodiment S52, wherein the system further comprises a sensor configured to sense a state of the at least one blocking element.

S165. The system according to any of the preceding system embodiments with the features of embodiment 813, wherein the system further comprises a force sensor configured to measure a force acting upon the at least one damping element.

In the below, reference will be made to reading element embodiments. These embodiments are abbreviated by the letter R followed by a number. Whenever reference is herein made to reading element embodiments, these embodiments are meant.

R1. A reading element wherein the reading element is configured to at least read data stored on a data element.

R2. The reading element according to the preceding embodiment, wherein the reading element is a QR reader.

R3. The reading element according to any of the preceding reading element embodiments, wherein the reading element is further configured to effect changes of the data on the data element.

R4. The reading element according to any of the preceding reading element embodiments, wherein the reading element is configured for wireless communication, such as communication via Bluetooth or RFID or proximity cards.

R5. The reading element according to any of the preceding reading element embodiments and without the features of embodiment R2, wherein the reading element is an NFC reader.

R6. The reading element according to any of the preceding reading element embodiments, wherein the reading element is configured to be used together with an insert comprising the features of embodiment I67, wherein the reading element comprises the master key, wherein the master key is preferably stored in a secure section of the reading element.

R7. The reading element according to any of the preceding reading element embodiments with the features of embodiment R4, wherein the reading element is configured for encrypted communication.

R8. The reading element according to the preceding embodiments, wherein the reading element is configured for symmetrically encrypted communication.

R9. The reading element according to any of the 2 preceding embodiments, wherein the reading element is configured for asymmetrically encrypted communication.

R10. The reading element according to any of the preceding system embodiments with the features of embodiments R4, wherein the reading element is configured for unencrypted communication.

In the below, reference will be made to data processing unit embodiments. These embodiments are abbreviated by the letter D followed by a number. Whenever reference is herein made to data processing unit embodiments or to DPU embodiments, these embodiments are meant.

D1. A data processing unit comprising the reading element according to any of the preceding reading element embodiments.

D2. The data processing unit according to the preceding embodiment, wherein the data processing unit further comprises a data processing means configured to at least store data.

D3. The data processing unit according to the preceding embodiment, wherein the data processing means is further configured to effect changes of the data stored in it.

D4. The data processing unit according to any of the two preceding embodiments, wherein the data processing means is configured to allow access to data stored in the data processing means based on a key.

D5. The data processing unit according to the preceding embodiment, wherein the data processing unit is configured to be used together with an insert comprising the features of embodiment I67, wherein the link to data stored in the data processing means is provided by the diversified key.

D6. The data processing unit according to the preceding embodiment, wherein the data processing unit is configured to allow only part of the data stored in the data processing means to be accessed using the diversified key.

D7. The data processing unit according to any of the preceding DPU embodiments,
wherein a tissue model data set is stored in the data processing means.

D8. The data processing unit according to the preceding embodiment, wherein the data processing unit is configured to be used together with an insert according to the insert embodiment I3, wherein the tissue model portion of the insert corresponds to the tissue model data set stored in the data processing means.

D9. The data processing unit according to any of the 2 preceding embodiments, wherein the tissue model data set stored in the data processing means is the data set from a medical image of a real tissue of a patient.

D10. The data processing unit according to any of the preceding DPU embodiments,
wherein the data processing unit is smart phone, a computer, or a tablet.

In the below, reference will be made to assembly embodiments. These embodiments are abbreviated by the letter A followed by a number. Whenever reference is herein made to assembly embodiments, these embodiments are meant.

A1. An assembly comprising the system according to any of the preceding system embodiments and the insert according to any of the preceding insert embodiments.

In the below, reference will be made to method embodiments. These embodiments are abbreviated by the letter M followed by a number. Whenever reference is herein made to method embodiments, these embodiments are meant.

M1. A method, wherein the method comprises using the assembly according to any of the preceding assembly embodiments.

M2. The method according to the preceding embodiment, wherein the insert is the insert according to any of the preceding insert embodiments, and the system is the system according to any of the preceding system embodiments with the features of embodiment S4,
wherein the method comprises the holder assembly releasably receiving the insert into the system.

M3. The method according to the preceding embodiment, wherein the system is the system with the features of embodiment S8, wherein the method comprises
forcing the insert forward in the insertion direction into the holder assembly to receive the insert into the system, and
forcing the insert opposite to the insertion direction out of the holder assembly to release the insert from the system.

M4. The method according to any of the preceding method embodiments, wherein the insert is the insert with the features of embodiment I36 and the system is the system with the features of embodiment S13, wherein the method comprises
forcing the insert forward in the insertion direction into the holder assembly until the at least one abutment section of the insert touches the at least one damping element of the holder assembly to receive the insert into the system, and
forcing the insert opposite to the insertion direction out of the holder assembly, to release the insert from the system.

M5. The method according to any of the preceding method embodiments, wherein the insert is the insert with the features of embodiments I15 and 136 and the system is the system with the features of embodiment S31, wherein the method comprises
forcing the insert forward in the insertion direction into the holder assembly until each of the at least one latching device is received into a respective latching recess and until the at least one abutment section of the insert touches the at least one damping element of the holder assembly to receive an insert into the system, and
forcing the insert opposite to the insertion direction out of the holder assembly until each of the at least one latching device is pushed out of the respective latching recess, to release an insert from the system.

M6. The method according to the preceding embodiment, wherein the insert is further the insert with the features of embodiment I28 and the system is further the system with the features of embodiment S29, wherein the method further comprises
aligning the plurality of contact sections of the connection portion of the insert with the plurality of contact sections of the groove such that the connection portion of the insert fits into the groove,
forcing the insert forward in the insertion direction into the holder assembly until each of the at least one latching device is received into a respective latching recess and until the at least one abutment section of the insert touches the at least one damping element of the holder assembly to receive an insert into the system, and
forcing the insert opposite to the insertion direction out of the holder assembly until each of the at least one latching device is pushed out the respective latching recess, to release an insert from the system.

M7. The method according to the preceding embodiment, wherein the system is further the system with the features of embodiment S56 and wherein the method comprises
aligning the plurality of contact sections of the connection portion of the insert with the plurality of contact sections of the groove such that the connection portion of the insert fits into the groove,
removing the blocking element from the path of reception of the insert,
forcing the insert forward in the insertion direction into the holder assembly until each of the at least one latching device is received into a respective latching recess and until the at least one abutment section of the insert touches the at least one damping element of the holder assembly, and
placing the blocking element in the path of reception of the insert, to receive an insert into the system.

M8. The method according to the preceding embodiment, wherein the method further comprises
removing the blocking element from the path of reception of the insert,
forcing the insert opposite to the insertion direction out of the holder assembly until each of the at least one latching device is pushed out of the respective latching recess, to release an insert from the system.

M9. The method according to the preceding embodiment, wherein the method further comprises placing the blocking element in the path of reception of the insert after releasing an insert from the system.

M10. The method according to any of the 2 preceding embodiments, wherein the system is further the system with the features of embodiment S61, wherein the method comprises
receiving an insert into the system, and
removing the blocking element from the path of reception of the insert,
operating the releasing element to push the insert opposite to the insertion direction, and
further forcing the insert opposite to the insertion direction out of the holder assembly until each of the at least one latching device is pushed out of the respective latching recess, to release the insert from the system.

M11. The method according to any of the preceding method embodiments, wherein the system is the system with the features of embodiment S73, wherein the method further comprises the system releasably receiving the soft tissue assembly.

M12. The method according to the preceding embodiment and with the features of embodiment M2, wherein the method comprises
receiving an insert into the system, and
receiving the soft tissue assembly into the system.

M13. The method according to the preceding embodiment, wherein the method further comprises,
releasing the soft tissue assembly from the system, and
releasing an insert from the system.

M14. The method according to any of the 3 preceding embodiments, wherein the system is the system with the features of embodiment S96, wherein the method comprises
receiving the soft tissue assembly into the system by aligning each of the at least one leg of the soft tissue holder with each of the at least one support hole of the holder assembly, and
lowering the soft tissue holder into the at least one support hole, to receive the soft tissue assembly into the system.

M15. The method according to the preceding embodiment, wherein the method further comprises
raising the soft tissue holder upwards from the at least one support hole to release the soft tissue assembly from the system.

M16. The method according to any of the preceding method embodiments, wherein the insert is the insert according to any of the preceding insert embodiments with the features of embodiment I53, and the system is the system according to any of the preceding system embodiments with the features of embodiment S145,
wherein the method comprises
the reading element reading data stored on the data element.

M17. The method according to the preceding embodiment, wherein the method further comprises authenticating the data element.

M18. The method according to any of the preceding method embodiments with the features of embodiment M17, wherein the insert comprises the features of embodiment I67 and the system comprises the features of embodiment S150,
wherein authenticating the data element comprises
   the system re-generating the diversified key by means of the master key and the ID,
   using the re-generated diversified key and the diversified key on the insert for verification.

M19. The method according to the preceding embodiment, wherein the authentication is deemed successful only when the re-generated diversified key matches with the diversified key on the insert.

M20. The method according to the preceding embodiment, wherein the system is the system with the features of embodiment S155, wherein the method further comprises
allowing access to the part of data linked to the diversified key stored in the data processing means only when the authentication has been successful.

M21. The method according to any of the preceding method embodiments with the features of embodiment M17, wherein the system is the system with the features of any of embodiments S145 and S147, wherein the method comprises
allowing access to the data stored on the data element only when the authentication has been successful.

M22. The method according to any of the preceding method embodiments with the features of embodiment M17, wherein the method further comprises
allowing a medical simulation only when the authentication has been successful.

M23. The method according to any of the preceding method embodiments with the features of embodiment M16, wherein the method comprises
changing a counter.

M24. The method according to the preceding embodiment with the features of embodiment M20, wherein the counter is stored in the data processing means.

M25. The method according to the penultimate embodiment, wherein the counter is stored on the data element.

M26. The method according to any of the preceding method embodiments with the features of embodiment M23, wherein the counter is changed only when a simulation procedure is detected to have been carried out.

M27. The method according to the preceding embodiment, wherein the counter is set to a certain, preferably positive, starting value and changing the counter comprises decreasing the value of the counter.

M28. The method according to any of the preceding method embodiments with the features of embodiment M23, wherein the counter is set to zero and changing the counter comprises increasing the value of the counter.

M29. The method according to any of the preceding method embodiments with the features of embodiment M23, wherein the counter is configured to have a preset value.

M30. The method according to the preceding embodiment, wherein the counter is not allowed to change in value after the preset value is reached.

M31. The method according to any of the preceding method embodiments with the features of embodiment M23, wherein the counter comprises at least one write-once memory section.

M32. The method according to the preceding embodiment, wherein the at least one write-once memory section is a plurality of write-once memory sections.

M33. The method according to any of the preceding method embodiments with the features of embodiment M16, wherein the method comprises reading and/or changing data comprising anatomical data.

For example, anatomical data can comprise details of the anatomy of the real tissue on which the tissue model of the insert is based, wherein the system is the system with the features of embodiment S159.

M34. The method according to any of the preceding method embodiments with the features of embodiment M16, wherein the method comprises reading and/or changing data comprising physiological data.

For example, the physiological data can comprise the medical history of a patient on whose tissue the tissue model of the insert is based, wherein the system is the system with the features of embodiment S159.

M35. The method according to any of the preceding method embodiments with the features of embodiment M16, wherein the method comprises reading and/or changing data comprising labeling data.

For example, labeling data can comprise names/labels of different parts of the tissue/bones in the tissue model of the insert.

M36. The method according to any of the preceding method embodiments with the features of embodiment M16, wherein the method comprises reading and/or changing data comprising medical imaging data.

M37. The method according to any of the preceding method embodiments with the features of embodiment M16, wherein the method comprises reading and/or changing data comprising treatment data.

For example, treatment data can comprise details of any previous medical procedures carried out on the real tissue on which the tissue model of the insert is based, wherein the system is the system with the features of embodiment S159.

M38. The method according to any of the preceding method embodiments with the features of embodiment M16, wherein the method comprises reading and/or changing data comprising spatial mapping data, and/or wherein the method comprises reading and/or changing planning data.

For example, spatial mapping data can comprise details of how to map parts of the tissue model of the insert to corresponding parts of a virtual tissue model in a simulation, wherein the system is the system with the features of embodiment S159.

M39. The method according to any of the preceding method embodiments with the features of embodiment M16, wherein the method comprises reading and/or changing data comprising physical model data.

For example, physical model data can comprise details of the material composition of the tissue model of the insert.

M40. The method according to any of the preceding method embodiments with the features of embodiment M16, wherein the method comprises reading and/or changing data comprising model usage data.

For example, model usage data can comprise details of prior simulations of medical procedures that have been carried out on the tissue model of the current insert.

M41. The method according to any of the preceding method embodiments with the features of embodiment M16, wherein the method comprises reading and/or changing data comprising logistical data.

For example, logistical data can comprise, among other details, any of serial number, batch number, manufacturing date, expiry date, or location of production.

M42. The method according to any of the 9 preceding embodiments, with the features of any of the embodiments M16 or M21, wherein the method comprises reading and/or changing the data stored on the data element.

M43. The method according to any of the preceding embodiments, with the features of embodiments M20 and any of the embodiments M33 to M41, wherein the method comprises reading and/or changing the data stored in the data processing means.

M44. The method according to any of the preceding method embodiments with the features of embodiment M16, wherein the method comprises reading and/or changing data of corresponding (or identical) inserts.

A2. The assembly according to any of the preceding assembly embodiments, wherein the assembly is configured to carry out the method according to any of the preceding method embodiments.

U1. Use of the assembly according to any of the preceding assembly embodiments in a method according to any of the preceding method embodiments.

[symbol]

Embodiments of the invention will now be described with reference to the accompanying drawings, which are intended to exemplify, but not to limit, the present invention.

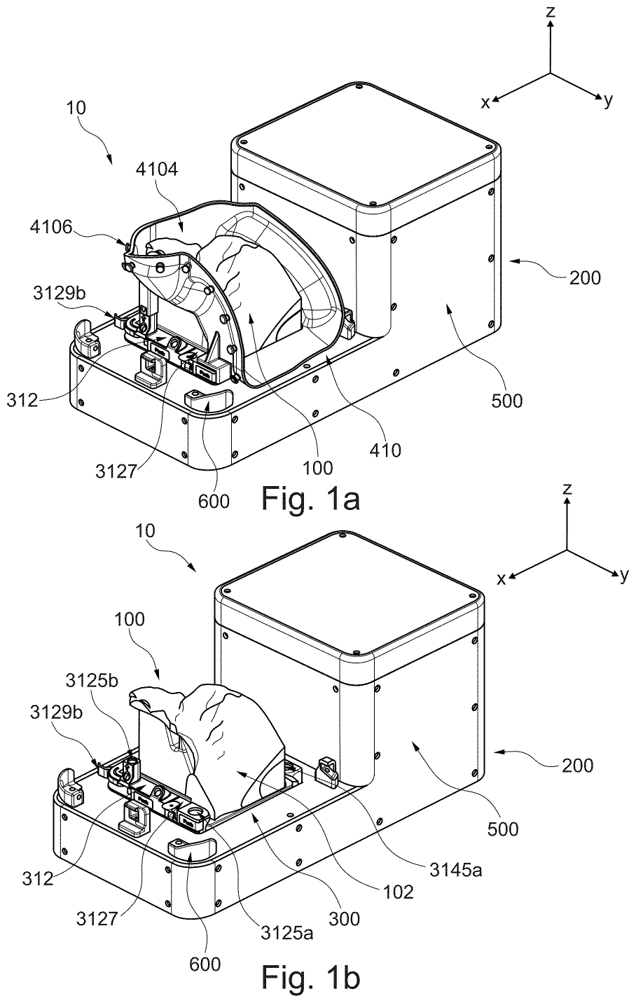

FIG. 1a depicts an assembly 10 comprising an insert 100 and a medical simulation system 200 comprising a soft tissue holder 410, a tracking system 500, and a plurality of fixtures 600, in a perspective view.

FIG. 1b depicts the assembly 10 with the soft tissue holder removed to reveal the holder assembly 300 and the insert 100, also in a perspective view.

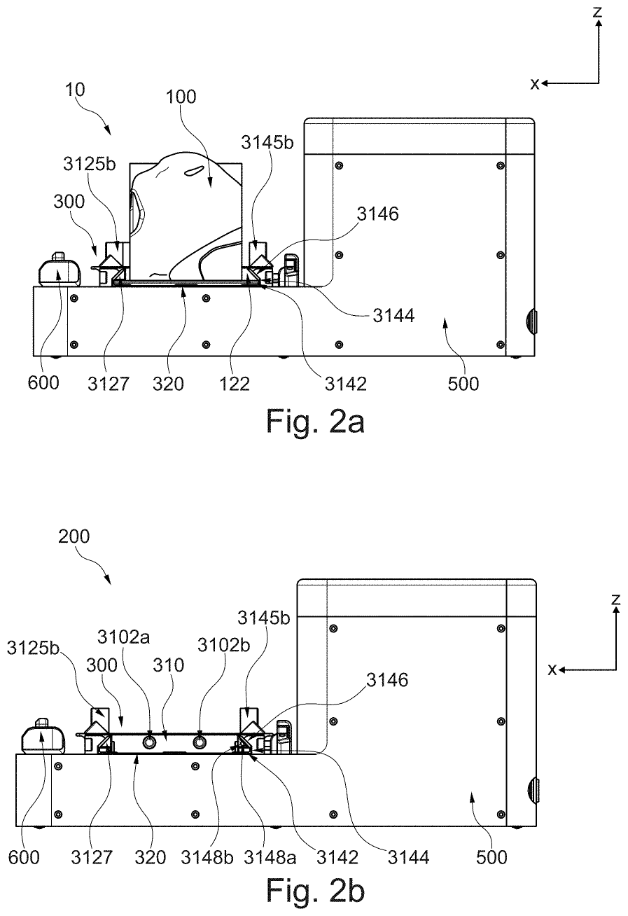

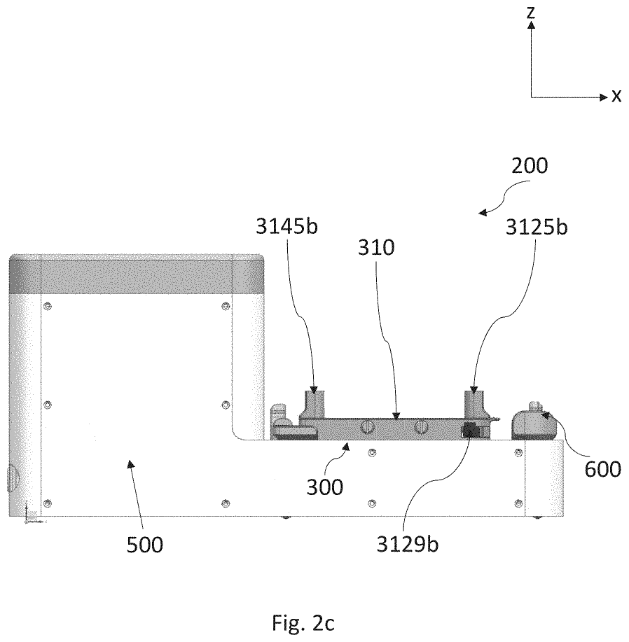

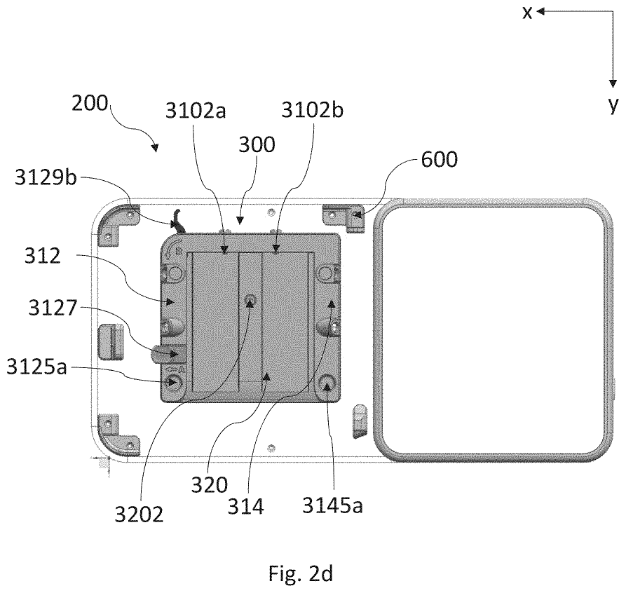

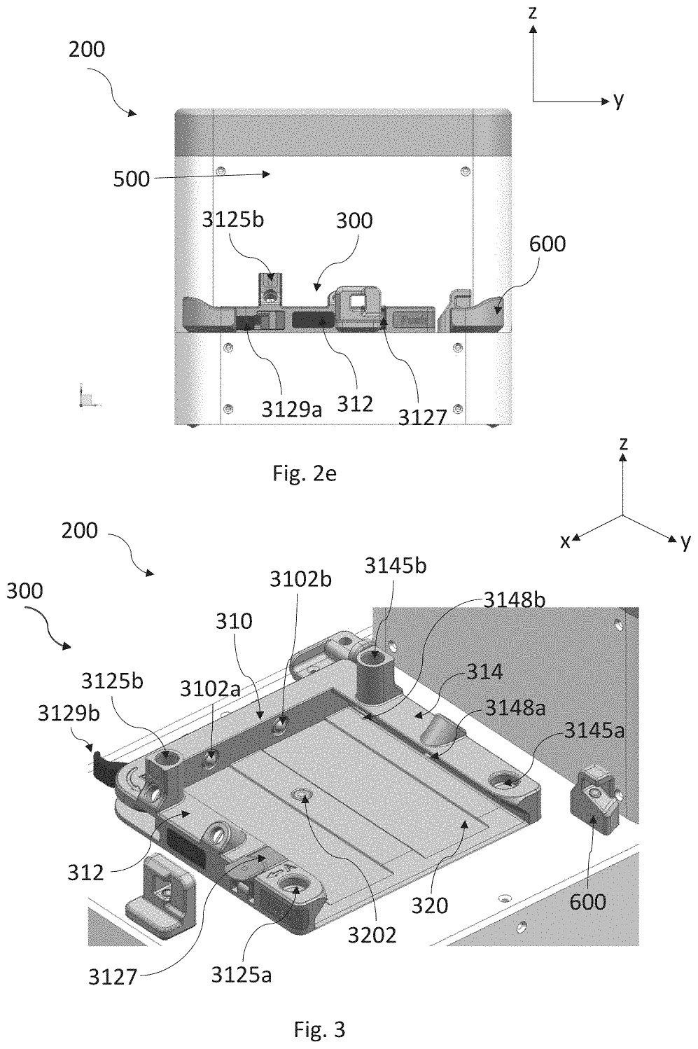

FIG. 2a depicts the assembly 10 with the soft tissue holder removed when viewed from the side, in a direction along the insertion direction.

FIG. 2b depicts the system 200 with the soft tissue holder and the insert 100 removed when viewed from the side in a direction along an insertion direction.

FIG. 2c depicts the system 200 with the soft tissue holder and the insert 100 removed when viewed from the side in a direction opposite to the insertion direction.

FIG. 2d depicts the system 200 with the soft tissue holder and the insert 100 removed when viewed from the top.

FIG. 2e depicts the system 200 with the soft tissue holder and the insert 100 removed when viewed from one side, in a direction perpendicular to the insertion direction.

FIG. 3 depicts the holder assembly 300 as oriented in the system 200 in a perspective view.

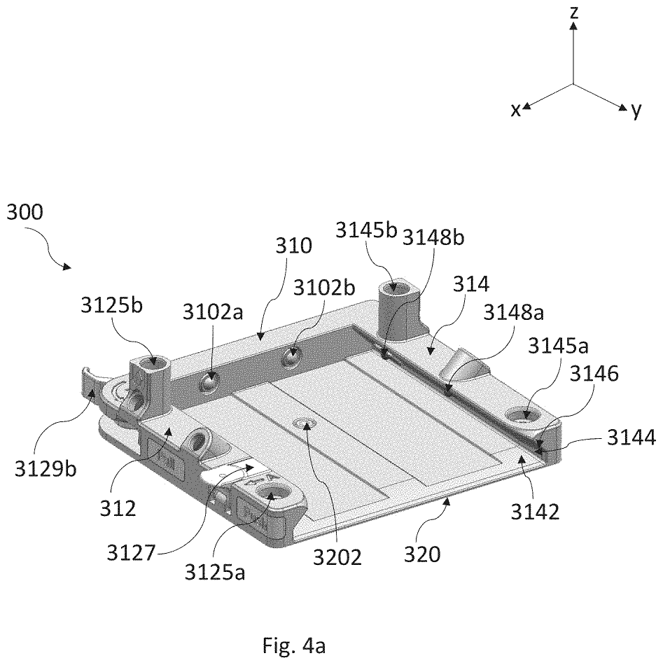

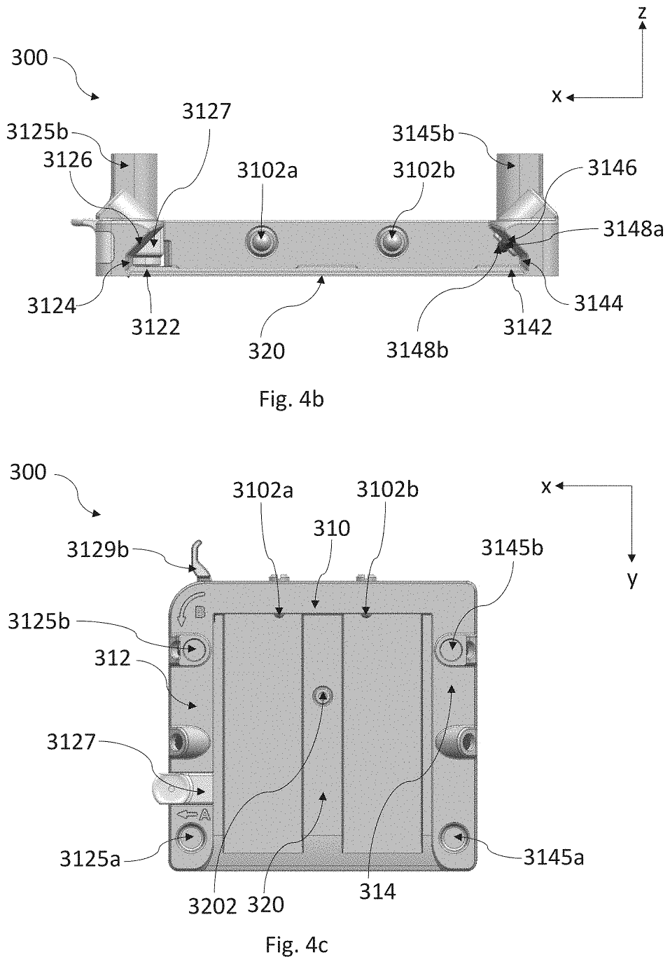

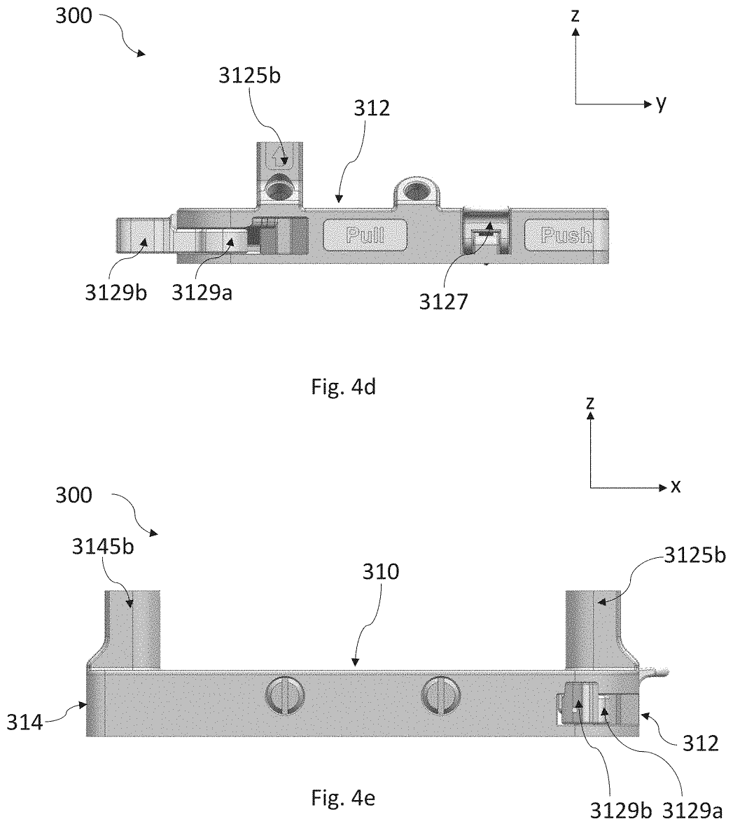

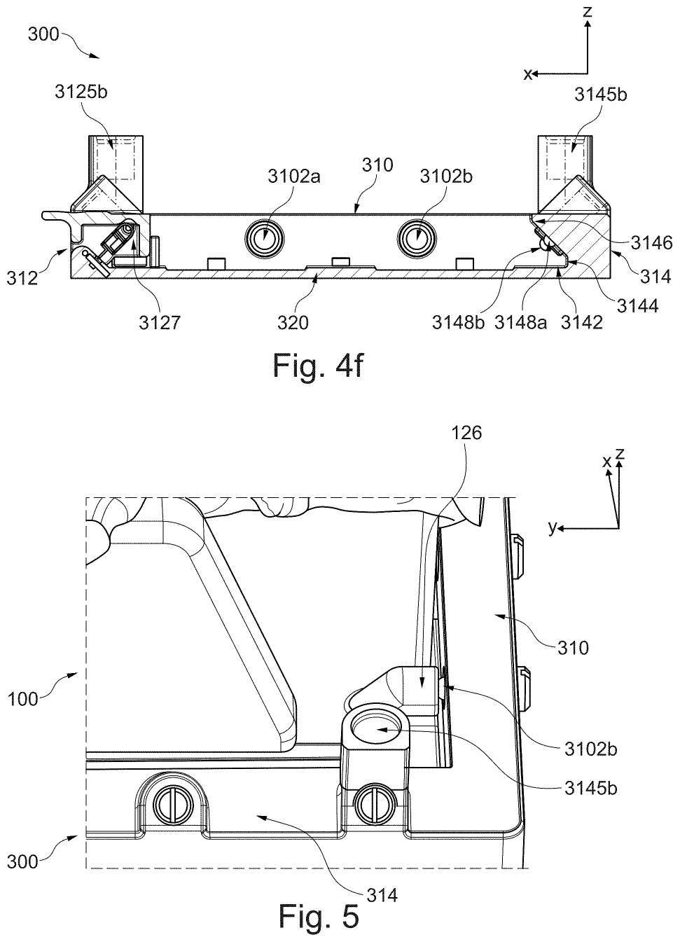

FIG. 4a depicts a zoom of the holder assembly 300 in a perspective view.

FIG. 4b depicts the holder assembly 300 when viewed from the side, in a direction along the insertion direction.

FIG. 4c depicts the holder assembly 300 when viewed from the top.

FIG. 4d depicts the holder assembly 300 when viewed from one side, in a direction perpendicular to the insertion direction.

FIG. 4e depicts the holder assembly 300 when viewed from one side, in a direction opposite to the insertion direction.

FIG. 4f depicts the same features as FIG. 4b, with some elements rendered transparent for better visibility.

FIG. 5 depicts a zoom of a section of the insert 100 in the holder assembly in a perspective view.

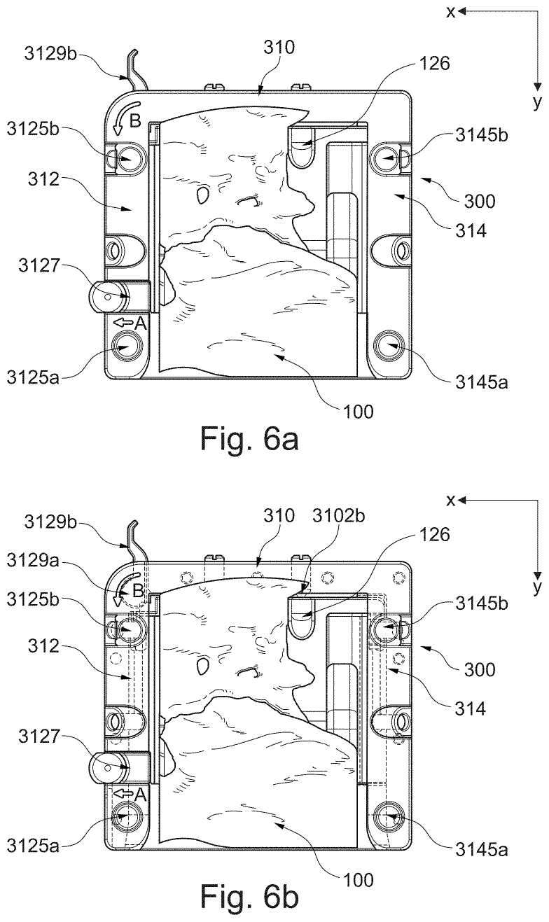

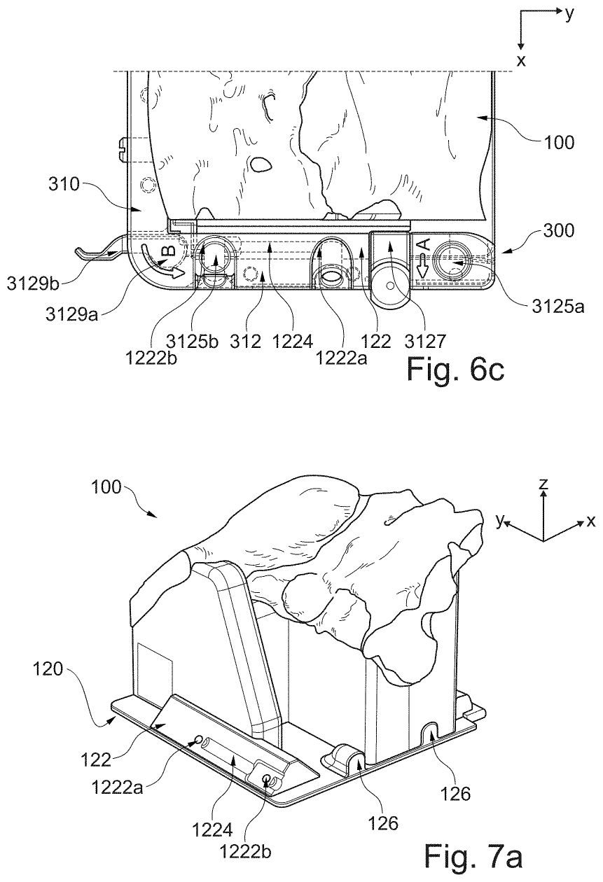

FIG. 6a depicts an insert in the holder assembly 300 when viewed from the top.

FIG. 6b depicts same features as FIG. 6a, with some elements rendered transparent for better visibility.

FIG. 6c depicts a zoom of an insert in a holder assembly, with some elements rendered transparent for better visibility.

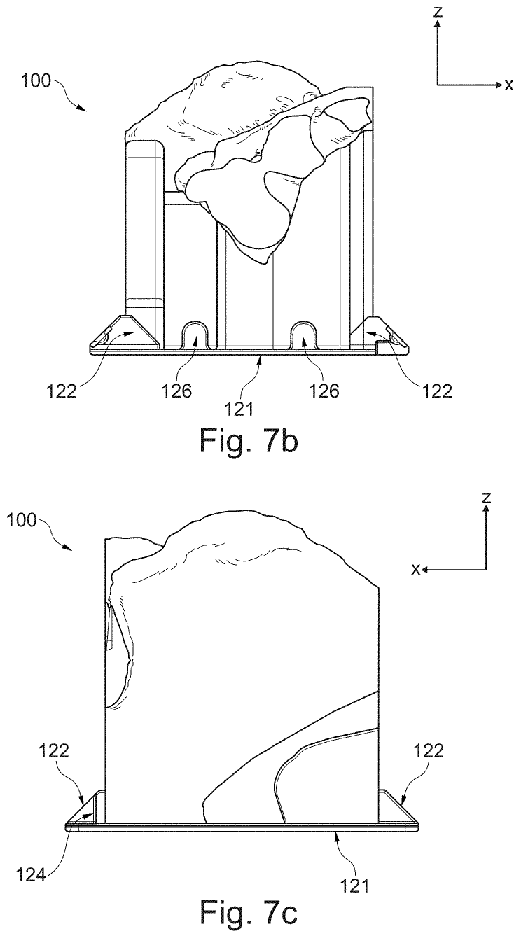

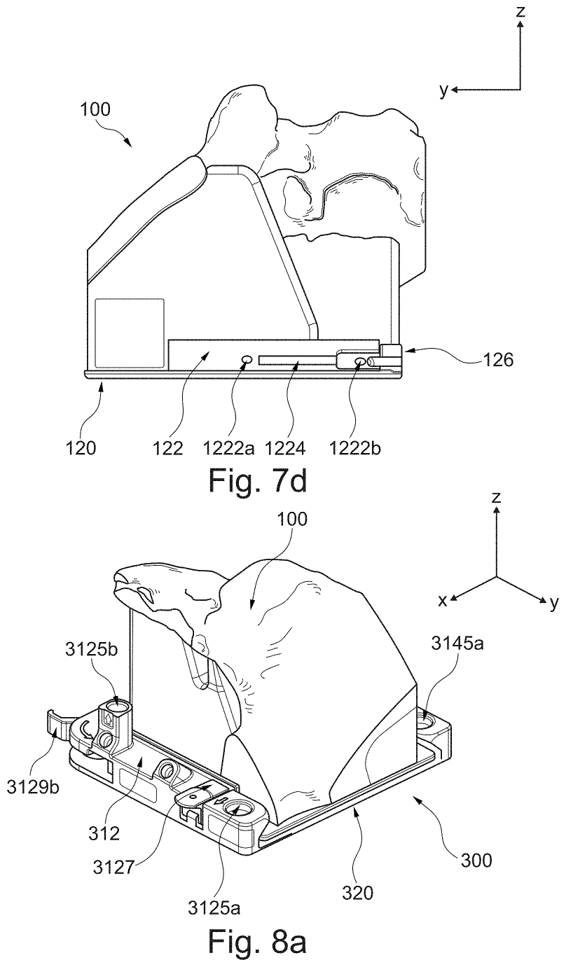

FIG. 7a depicts a zoom of the insert 100 in a perspective view.

FIG. 7b depicts the insert 100 when viewed from the side, in a direction opposite to the insertion direction.

FIG. 7c depicts the insert 100 when viewed from the side, in a direction along the insertion direction.

FIG. 7d depicts the insert 100 when viewed from one side, in a direction perpendicular to the insertion direction.

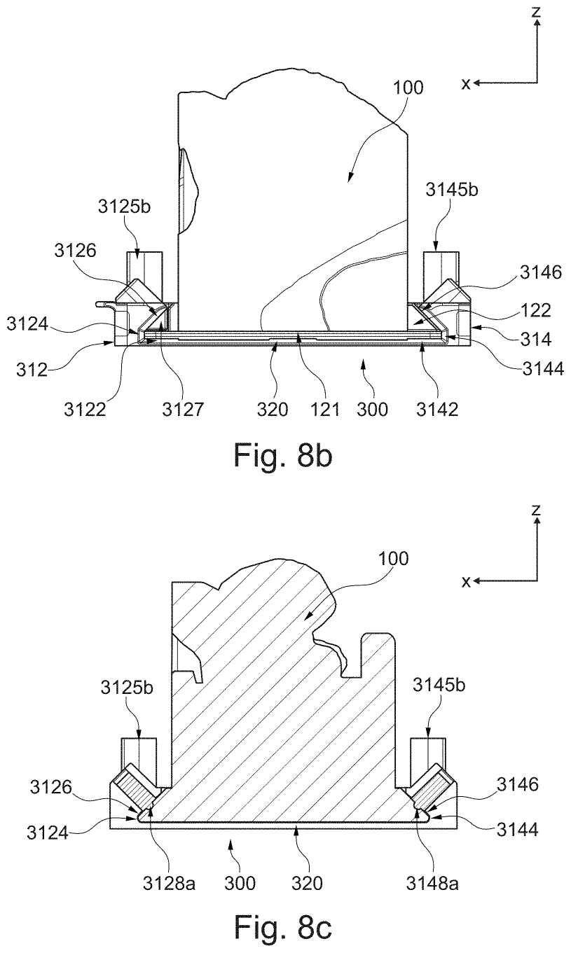

FIG. 8a depicts the insert 100 in the holder assembly 300 in a perspective view.

FIG. 8b depicts the insert 100 in the holder assembly 300 when viewed from the side, in a direction along the insertion direction.

FIG. 8c depicts a cross section view of the insert 100 in the holder assembly 300, when viewed from the side, in a direction along the insertion direction.

For sake of simplicity, not every drawing comprises all the reference signs. Instead, in some of the drawings, some reference signs have been omitted for simplicity and clarity of the drawings.

FIG. 1a depicts one embodiment of an assembly 10 for carrying out a realistic simulation of a medical procedure. The assembly 10 comprises a system 200 and an insert 100, which together form the assembly 10. Such an assembly 10 may be used e.g. by a medical trainee to carry out practice simulations of medical procedures, or by a trained surgeon to plan a complicated procedure. By realistic is meant a simulation comprising haptic feedback being provided to the person carrying out the procedure as well as a realistic response of the model tissue, which may comprise any of hard bone tissue or soft tissue, to the forces applied by the practitioner during the medical intervention.

In order to achieve the above goal of a realistic simulation, the assembly 10 comprises at least two sections—a physical tissue model 100, which may also be called an ‘insert’, and which may represent a portion of the vertebrae for example, and a tracking system 500. The tracking system may be configured to track the position and/or orientation of at least one part of the insert 100. For the purposes of tracking, a calibration of the position and/or orientation of the at least one part of the insert 100 may be made available to the tracking system 500. Further details of the tracking system have already been disclosed in EP 3355215 A1.

The tracking system may use a combination of magnetic field generators and sensors to track the positions and/or orientations of various components. As a result, it may be preferable to eliminate magnetic materials, i.e. materials which have a high magnetic susceptibility, as far as possible in the construction of the assembly 10. An example of such materials are metals, and thus use of metals may be sought to be minimized in constructing the system 200.

Accordingly, one preferred material may be plastic and its different embodiments. Instead of screws, glue may be used to attach different parts together.

The insert 100 may be changed, while keeping the tracking system 500 intact. That is, the insert 100 may generally be adapted to be releasably connected to the system 200, as will be described in further detail below. In further preferred embodiments, the calibration information of the tracking system 500 may also be kept intact, allowing a fast and easy plug-and-play simulation of a medical procedure. This may be enabled by a holder assembly 300, configured to receive an insert 100. Further, the calibration data may not be changed for a new insert. In embodiments, the insert 100 and the system 200 may further be provided with means to determine the calibration, for e.g. by exchanging and processing spatial mapping data between the system and the insert.

Further realism of the simulation may be achieved by enabling the tissue model 100 to be covered by a ‘skin’ as in a real medical procedure. For this purpose, a soft tissue assembly comprising an artificial skin section (not shown) may also be configured to be detachably attached to the system 200. The artificial skin may be releasably attached to a soft tissue holder 410 such that it covers, at least in part, the insert 100. This skin may be made of, at least in part, any of silicone, unsaturated rubber such as natural rubber, latex, chloroprene, polyurethane, poly vinyl chloride, elastomers, leather. In preferred embodiments, the soft tissue holder 410 may be secured on the holder assembly 300.

The soft tissue holder may further be filled by an artificial soft tissue, to provide further realism to the simulation. In embodiments, this soft tissue may be made of any semi-solid or hydro or polymer-based gels.

A further opaque cover may be provided, that rests on the plurality of fixtures 600. The further opaque cover may comprise an open section to allow access to the skin attached to the soft tissue holder 410 that hides the underlying tissue model 100. The further opaque cover may optically cover the rest of the system 200 so that only the skin model may be visible.

A typical medical procedure may then be carried out with only a part of the skin visible to the practitioner, thus realistically simulating the actual procedure. For example, the procedure may comprise inserting a pin through the skin and hammering it into the tissue, passing a drill over the pin to drill a hole into the tissue and inserting an implant over the pin into the hole. The whole process of hammering and implant placement may be tracked by tracking the position and/or orientation of at least one part of the tissue model, and/or the position and/or the orientation of any of the cannula and trocar needle. In one embodiment, this tracking may be achieved by equipping all the parts to be tracked with magnetic field sensors and by equipping the tracking system 500 with a magnetic field generator. Alternatively, it may be possible to track the process with the help of calibration data that may help locate the insert in space and data about the physical tissue model.

FIG. 1b shows one embodiment of assembly now with the soft tissue holder 410 removed. This configuration serves as an initial step to allow the insert 100 to be replaced in some embodiments. It may also be used to visually assess the usability of the insert 100 for a procedure after an earlier procedure. It may also be used to visually assess the accuracy of the position of, for example, a pin or implant in the model tissue.

FIG. 2a depicts one embodiment of the assembly 10 from the side, with an insert 100. FIGS. 2b and 2c depict embodiments of the system 200 without the insert 100 when viewed from the side, in one direction and in the opposite direction, such that the holder assembly 300 and the tracking system 500 are not in the same line of sight.

As is depicted in FIG. 2a, the vertical height of the tracking system 500 measured from the base of system 200 may be larger than the height of the top of the holder assembly measured from the base of system 200.

An insert 100 may be inserted or plugged into the holder assembly 300, by sliding or pushing it relative to the base of the holder assembly 300, from at least one side of the holder assembly that is open. The side from which the insert is inserted into the holder assembly may also serve to define the direction in which a significant part of the force may be applied to the insert during simulation of a medical procedure. Generally, the insert 100 being slid into the holder assembly 300 may define an insertion direction, and the assembly 10 may be adapted to withstand and dampen substantial forces applied in this direction (but not in the opposite direction). With general reference to FIG. 1b, it will be understood that the insertion direction is opposite to the y-direction as indicated by the coordinate system. That is, the insert 100 may be slid into the system 200 along the −y-direction and may be removed from the system 200 along the y-direction. The insert 100 represents a bone and may have a main intervention section 102. For example, the assembly 10 may be used to simulate a needle being hammered into the main intervention section 102. It will thus be understood that it may be desirable that the assembly is configured to withstand and dampen forces supplied in the insertion direction.

As depicted in FIG. 2b, the holder assembly may comprise at least one stopping element 310, which may be a vertical section, that limits the distance to which the insert may be pushed along base of the holder assembly. This stopping element 310 may contribute to the assembly being configured to withstand forces applies to the assembly 10 along the insertion direction. The height to which the top of element 310 rises above the base of the system 200 may be less than the height to which the tracking section 500 rises above the base of the system 200. In embodiments, the height of element 310 may be at least large enough to accommodate various elements that may be provided in the element 310.

FIG. 2c depicts the system 200 from the opposite side as in FIG. 2b. The damping elements 3102a, 3102b are shown to be connected through screws to the stopping element 310.

FIG. 2d shows system 200 as viewed from the top, such that the tracking system appears to the right of the holder assembly. The holder assembly 300 may be configured to have dimensions such that it lies entirely within the boundaries of the system 200 at any time in the course of simulation of a medical procedure. In embodiments, a plurality of components that may comprise the holder assembly may be allowed to extend beyond the boundaries at any time in the course of simulation of a medical procedure.

FIG. 2e depicts the system 200 when viewed from the side such that the holder assembly and the tracking system are in the same line of sight and such that the holder assembly is in front of the tracking system. The holder assembly may be centered with respect to the tracking section or be displaced from it.

FIG. 3 depicts the holder assembly 300 in a perspective view as located in the system 200. FIG. 4a depicts the holder assembly 300 in a perspective view. FIG. 4b depicts the holder assembly 300 in a side view. FIGS. 4c-4f depict the top and different side views of the holder assembly 300 respectively. FIGS. 5-6c depict different views of the holder assembly with an insert, with some elements rendered transparent to aid visibility.

The holder assembly will now be described in greater detail with reference to these figures.

In the present embodiment, the holder assembly 300 is configured to receive the insert 100 and keep it locked in position as well as to receive the soft tissue assembly 400. In other embodiments the holder assembly may not receive the soft tissue assembly 400.

E.g., in order to enable the holder assembly to receive the soft tissue holder 410 at least one, preferably at least two, and more preferably at least four supporting holes, labelled as 3125a, 3125b, 3145a, 3145b in FIG. 4a, may be provided on the top of a plurality of latching elements 312 and 314 of the holder assembly 300. The soft tissue assembly may then comprise at least one, preferably at least two, and more preferably at least four legs which may fit into these four holes such that the soft tissue assembly 400 merely rests on the holder assembly. It will be apparent to those skilled in the art that it is also possible to use other methods to enable the soft tissue assembly to rest on top of the holder assembly.

The orientation of any of the holes may be described using their axis, which is assumed to be the line passing through the center of the hole and around which the hole is circularly symmetric. In embodiments, the axes of at least two holes may be parallel to each other, and preferably the axes of all the holes may be parallel to each other.

In preferred embodiments with at least four holes, they may be divided into two pairs, with one pair lying on either side of the insertion direction. In embodiments, the holes in any of the two pairs may lie on the same latching element of the holder assembly 300. In other embodiments, the holes in any of the two pairs may not lie on the same latching element of the holder assembly 300. As may be apparent to those skilled in the art, different placements of the supporting holes may be used to achieve the same effect.

In embodiments where the holes in any of the two pairs lie on the same latching element of the holder assembly they may be placed far apart so as to span most of the width of the holder assembly in the insertion direction. This may allow a more stable placement of the soft tissue assembly 400 on top of the holder assembly.

For a realistic simulation of a medical procedure it may be desired to have the soft tissue assembly representing a side of a waist or back on which the procedure is performed. In this case, it may be desirable to have the soft tissue holder arc downwards, with the soft tissue holder being higher on the anterior side of the insertion direction, and lower on the posterior side. This may be achieved by having the at least one leg, and preferably the at least two legs, supporting the soft tissue assembly on the anterior side of the insertion direction longer than the other legs. Accordingly, in the present embodiment, each of the holes 3125b and 3145b that support the longer legs are provided with a short tube to buttress any impact from a simulated medical procedure which may involve applying force normal to the slope of the arcing soft tissue assembly.

The core of the holder assembly 300 comprises a latching mechanism that allows an insert to be latched on to the holder assembly by pushing it in a defined direction, which may be called an insertion direction. A simulation of a medical procedure may then be carried out on the insert 100. It may also be desirable to replace the insert 100 with a new one for a new simulation of a medical procedure, for which purpose the latching mechanism may be released and the insert 100 may be pulled or pushed out of the holder assembly 300. In the present embodiment, the release of the latching mechanism is achieved by pushing the insert 100 out of the holder assembly 300.

In one embodiment (see, e.g. FIG. 4a), the holder assembly 300 comprises at least one stopping element 310. The stopping element 310 lies on the anterior side of the insertion direction, and is preferably orthogonal to the insertion direction such that it limits the insertion of insert 100 into the holder assembly. The stopping element 310 may comprise a plane on the face that is allowed to come in contact with the insert 100.

A plurality of dampening elements 3102a, 3102b may further be provided on the stopping element 310. The dampening elements 3102 may serve to buttress impacts on the insert 100 when a simulation of a medical procedure requires force to be applied on the insert, for e.g. when hammering a cannula. They may also serve to provide additional haptic feedback during the simulation of a medical procedure. In preferred embodiments at least 2 dampening elements, 3102a and 3102b, may be provided on the stopping element 310.

The dampening element may comprise knobs having at least two faces. One face may be attached to one end of a spring with a defined spring constant, while the other face is allowed to come in contact with the insert when the insert is latched into the holder assembly. The other end of the spring may be attached to the stopping element 310 such that it is not allowed to move. Thus, a large restoring force may be provided to the insert when pushed against the plurality of dampeners 3102.

The knob of any of the dampeners 3102a, 3102b may comprise plastic, or rubber, or other non-brittle materials. The knob may be rounded at its point of contact with the insert to minimize impact on the insert due to a reaction force when the insert is pushed against the knob due to impacts during simulation of a medical procedure.

The holder assembly 300 may further comprise at least one latching element 312, preferably two latching elements, 312 and 314, that abut the insert 100. Any, and preferably both, of the latching elements 312 and 314 may be parallel to the insertion direction. Any, and preferably both, of the latching elements 312 and 314 may be joined to the stopping element 310 to form a closed U-shape comprising the holder assembly 300.

As depicted in FIG. 4b, the latching elements 312, and 314 may comprise grooves on the faces in contact with the insert 100. These grooves may comprise an angled ceiling formed by the underside 3126, 3146 of the tops of latching elements 312, or 314, such that the groove is widest at the bottom and narrowest at the top. These angles may be chosen to be in the range of 10° to 80°, preferably 30° to 60°, further preferably 40° to 50° with respect to a base 320 of the holder assembly which may also comprise a basal planar surface 3122, 3142 of either of the two grooves. A corresponding planar contact surface 122 (see FIG. 7a) may be provided on the insert 100 that may allow it to fit in and be easily guided into the holder assembly.

The latching element 312 may be more distant from the tracking system 500 than the latching element 314. This may allow the latching element 312 to be adapted to fit an easily-operable release mechanism that may allow the insert 100 to be released from the holder assembly. In the present embodiment, this mechanism is provided with the help of the releasing element 3129 (FIG. 4a).

The releasing element 3129 may preferably be located at the corner where elements 310 and 312 may meet. Alternatively, it may be located entirely on either of the elements 310 or 312, but preferably not on element 314 to allow sufficient space for operating it. In the present embodiment, the releasing element 3129 is configured to push the insert out of the holder assembly for release. Further details of the structure of element 3129 are shown in FIG. 6c.

Element 3129 may comprise a head 3129a and a tail 3129b (see, e.g., FIGS. 4d and 6b). In the present embodiment, the head 3129a comprises a semi-circle that is stretched along the direction perpendicular to its diameter such that it comprises a segment of a circle joined together with a rectangle of length equal to the diameter of the original semi-circle. In the present embodiment, this head is constrained to pivot around a fixed axis passing vertically through the center of the corner formed by elements 310 and 312 and through the middle of the head.

The tail region 3129b comprises a (long) section perpendicular to the diameter of the semi-circle and joined to the semi-circle at one end of its diameter. The width of the perpendicular section may be chosen to be less than the diameter of the semi-circle, so that a small nook is left free in the part of the diameter that is not connected to the tail. The perpendicular section is terminated by an elongated hook that curves inwards in the direction of the pivot.

The hook may be used to push element 3129 into a locking position and the free end of the hook may be used to pull element 3129 out of the locking position. The element 3129 is sandwiched between the top and bottom of elements 310 and 312 which may be provided with a recess on the outside as well to accommodate element 3129. This configuration of element 3129 allows it to rotate by an angle of almost 180 degree, wherein the locking position element 3129 is closed such that both its tail 3129b and head 3129a are contained within the holder assembly 300 while in the release position the head 3129a of element 3129 remains in the holder assembly 300 but its tail 3129b may protrude out of the holder assembly as shown in FIG. 6b, 6c.

The radius of the semi-circle may be chosen to be small enough that the element 3129 may be fully rotated from a release position to a lock position with the insert 100 already present in the holder assembly. The locking is completed when the nook is positioned behind the insert in the anterior side of the inserting direction. When the insert is sought to be released, the hook of element 3129 is pushed back by 180 degree, which causes the nook to push on the insert thereby releasing it.

A blocking element 3127 may also be provided in embodiments of the present technology (see, e.g., FIG. 4a). This blocking element 3127 may be provided on the element 312 as well. In embodiments it may be provided on element 314. In the present embodiment, this blocking element 3127 serves to keep the insert 100 in position, and prevent the insert 100 from being removed from the holder assembly 300.

The blocking element 3127 may be configured to be immovable in the insertion direction and movable in a plane perpendicular to this direction. The movement in the perpendicular plane may allow it to be placed in the path of insertion of the insert 100. In the present embodiment, this movement in the perpendicular plane is achieved by allowing the blocking element 3127 to pivot about an axis parallel to the insertion direction and passing through the middle of the blocking element 3127. The blocking element 3127 may be connected to a spring that in its equilibrium state keeps part of the block in the insertion path. By pushing one end of the blocking element 3127, it may be pivoted out of the insertion path and subsequently released after the insert has been pushed in to lock the insert in-place.

A notch 124 may be shaped into the insert such that the block in its released state fits into this notch, once the insert 100 is positioned inside the holder assembly. Alternatively, as in the present embodiment, the notch 124 may be a channel, shaped like a prism as shown in FIG. 7c, into a part of which element 3127 fits, as shown in FIG. 8b.

Any of the elements 312 and 314 may be further provided with at least one latching device to enable a tighter hold on to the insert. In the present embodiment, 4 latching devices, 3128a, 3128b, 3148a, and 3148b are provided. In this regard, exemplary reference can be made to FIG. 4a depicting latching devices 3148a, and 3148b, and it should be understood that corresponding latching devices 3128a, 3128b are also comprised by element 312 (though not visible in the perspective of FIG. 4a). In the embodiments depicted in the figures, the latching devices 3128a, 3128b, 3148a, and 3148b are realized as latching balls. However, it should be understood that this is not a necessity and the latching devices may in fact also be realized in a different manner, e.g., as latching pins. That is, when in the description of the figures, reference is made to latching balls, it should be understood that this is merely exemplary and that embodiments of the present invention may also use latching devices being different from latching balls.

The latching balls may be positioned as pairs on either or both of the elements 312 and 314 such that there is one pair on each side of the insert 100. They may provide additional stability to the insert when it is subjected to forces. A plurality of latching balls and their angled orientation may also provide stability against translation and rotation in the horizontal plane when a simulation of a medical procedure is carried out.

In the present embodiment, these latching balls are connected to springs so that they may be pushed back, for example, when the insert is pushed into the holder assembly. They are positioned to latch on to the insert 100 normally to the planar contact surface 122 (see FIG. 7a), which may provide a better grip. In addition, in the present embodiment, the pair of latching balls closer to the element 310 are configured to go deeper into a recess in the insert. This may also provide additional stability to the insert when subjected to forces.

The holder assembly 300 may also comprise a base 320. The base may contain a marker, shown in FIG. 4a as a circle 3202 in the middle of the base 320. This marker may be used to map the position of the holder assembly into a virtual model that may contain a virtual model of the physical tissue model comprising the insert 100.

As may be apparent to those skilled in the art, while the above has been described with respect to particular shapes and positions employed in the present embodiment, the shapes and positions may be changed in embodiments without changing the technical effect, which is to allow inserts to be latched to and released from the holder assembly 300. In addition, while the above description has described elements 310, 312, and 314, these may not be uninterrupted sections but may each comprise a plurality of elements described above, individually attached to the system 200.

The insert 100 may comprise a physical tissue model, wherein physical means a tangible tissue model. The tissue model may represent, for example, a bone tissue or a soft tissue or a combination of both. FIGS. 7a-7d show various views of the insert. Reference will now be made to these figures to describe the insert.

It may comprise a connection portion 120 to be pushed relative to the base of the holder assembly. The connection portion 120 may also represent the mechanisms for releasably connecting the insert 100 with the system 200. The connection portion 120 may comprise a planar connection surface 121 which is shown in FIG. 7b as the base of the insert 100. The connection portion may further comprise a plurality of contact sections 122 which are configured to allow the insert to be easily aligned and pushed into the holder assembly 300. To this end, the contact sections may be made inclined to the planar connection surface 121. In embodiments, this angle may be chosen to be in the range of 10° to 80°, preferably 30° to 60°, further preferably 40° to 50°.

The contact sections may further comprise latching recesses 1222a, 1222b to accommodate latching balls that may be provided in the holder assembly. One of these latching balls may be more backward in the insertion direction than the other. In order to minimize friction due to the first latching ball encountered while pushing the insert into the holder assembly, a channel 1224 may be provided for this first latching ball. The depth of this channel may be chosen deep enough to allow the first latching ball to apply close to no force on the insert.

The insert may further comprise a plurality of abutment sections 126. These abutment sections may be abutted by damping elements 3102 of the holder assembly. The abutment sections may serve to buttress some of the impact generated by forces applied on the insert during simulation of a medical procedure.

FIGS. 8a and 8b depict views of the insert 100 in the holder assembly 300. FIG. 8c shows a cross sectional view of the insert in the holder assembly. As shown in FIG. 8c, in the present embodiment, the latching balls on either side of the insertion direction serve to lock the insert in place.

The assembly 10 may further comprise elements to enable exchange of data between the insert 100 and the system 200. Such exchange may be made possible, for example, with the use of a data element on the insert 100, which may at least be read by a reading element present in the system 200. For example, in the present embodiment, the data element may be an NFC tag configured to fit into a recess (not shown) that may be provided on the outer planar connection surface 121. Alternatively, the data element may be an NFC tag embedded into the insert 100. For example, when the insert is a 3D printed insert 100, the printing process may be performed until a certain stage, at which stage the printing process is interrupted, a data element may be inserted, and the printing process may be continued afterwards, such that the data element is fully embedded in the insert and not visible outside (which is why the data element is not visible in the depicted embodiments).

In other embodiments (not depicted), the data element may also be provided at an outside surface of the insert 100. Generally, the data element on the insert 100 may comprise a bar code, such as a QR code, or a chip configured for wireless communication, such as a Bluetooth or RFID chip. In preferred embodiments, the data element comprises an NFC tag. One advantage of the above implementations may be that they are passive, i.e., the data element on the insert 100 may not need to be supplied with energy for it to function.

A corresponding reading element may also be provided in the system 200, such as a bar code reader, or a Bluetooth or RFID detector. As an example, the reading element may be located at 3202 (see FIG. 4c), but it should be understood that this is merely exemplary and that the reading element may also be located at other locations in the system. In preferred embodiments, the reading element comprises an NFC reader. An advantage of using an NFC connection to exchange data may be the possibility to embed NFC tags inside the insert 100 instead of on the outer surface, that may be required for a bar code. This may help prevent tampering of information on the data element, or removal or exchange of the data element with another data element.

Using an NFC tag and an NFC reader may also be advantageous, as the insert 100 (by means of its NFC tag) will only be “found” by the system 200 (by means of its NFC reader) when the two are in close proximity, e.g., when the insert 100 is inserted into the system. This may be advantageous, e.g., in situations where more than one insert is in a room, as only the insert 100 actually inserted into the system 200 may be registered by the system.

In preferred embodiments, the NFC connection may be used to allow authentication of the insert 100. Authentication may help to ensure accuracy of correspondence between the physical tissue model and its virtual representation. This accuracy may be advantageous in embodiments where the virtual representation may be used to guide the simulation of a medical procedure, for example during training or for planning of a complex medical procedure to be carried out on a real tissue on which the physical model of the tissue may be based.

In embodiments, this may be made possible by using a secret key.

The authentication may be achieved in two steps. In a first, setting-up step, the data element on the insert 100 may be configured to store a unique ID. Further, the system 200 may be configured to have a secure section in which a master key may be stored. The system 200 may read the unique ID of the insert and may then use both the master key and the unique ID, to generate a diversified key. In preferred embodiments, a secure section may be further provided on the data element to store the diversified key generated by the system 200. This secure section may be further configured to allow only reading of data once the diversified key has been stored in it. This may comprise a first step.

In a second step, corresponding to the authentication itself, the system 200 may then use the master key, stored in its secure section, and the unique ID, that may be read off the data element on the insert 100 by the reading element in the system 200, to generate a diversified key. This diversified key may be compared to the one stored on the data element, once again by reading off the diversified key with the reading element. If the generated diversified key matches with the one stored on the data element of the insert 100, authentication may be deemed successful. The system 200 may then only allow a simulation of a medical procedure subject to successful authentication.

The data element may be further configured to allow changes to be made on the data stored on it. Correspondingly, the reading element in the system 200 may be further configured to allow it to effect changes in the data on the data element.

In embodiments, different types of data may be further stored on the data element. In preferred embodiments, these data may be stored in an unsecure section of the data element. Various examples of different data that may be stored will now be provided.

A first category of data that may be stored on the data element may comprise a counter. This counter may be changed once a simulation of a medical procedure is detected to have been carried out. The counter may be configured to disable changes once a certain pre-determined value is reached. The counter may initially be set to a zero value and may count up to the pre-determined value. Alternatively, the counter may initially be set to a value larger than the pre-determined value and may count down to it.

A second category of data that may be stored on the data element may comprise anatomical data. This may comprise, for example, details of the anatomy of the real tissue on which the tissue model of the insert 100 is based in embodiments where the physical tissue model is based on real tissue.

A third category of data that may be stored on the data element may comprise physiological data. This may comprise, for example, the medical history of a patient on whose tissue the tissue model of the insert 100 is based in embodiments where the physical tissue model is based on real tissue.

A fourth category of data that may be stored on the data element may comprise labeling data. This may comprise, for example, the names and/or labels of different parts of the tissue and/or bones in the tissue model of the insert 100. Such data may be advantageous if the assembly is used for training purposes.

A fifth category of data that may be stored on the data element may comprise medical imaging data. This may comprise, for example, imaging data from computed tomography, magnetic resonance imaging, X-ray imaging, positron emission tomography, ultrasound, and other imaging techniques.

A sixth category of data that may be stored on the data element may comprise treatment data. This may comprise, for example, details of any previous medical procedures carried out on the real tissue on which the tissue model of the insert 100 is based in embodiments where the physical tissue model is based on real tissue.

A seventh category of data that may be stored on the data element may comprise spatial mapping data. This may comprise, for example, details of how to map parts of the tissue model of the insert 100 to corresponding parts of a virtual tissue model in a simulation in embodiments where the system 200 comprises a virtual tissue model corresponding to the physical tissue model.

An eighth category of data that may be stored on the data element may comprise physical model data. This may comprise, for example, details of the material composition of the tissue model of the insert 100.

A ninth category of data that may be stored on the data element may comprise model usage data. This may comprise, for example, details of prior simulations of medical procedures that have been carried out on the tissue model of the current insert 100. This may further comprise assessment scores of prior simulations that may be useful when the system 200 is used for training or may include details of who carried out the simulations and an ID of the simulation system used with the insert.

A tenth category of data that may be stored on the data element may comprise logistical data. This may comprise, for example, comprise, among other details, any of serial number, batch number, manufacturing date, expiry date, or location of production.

An eleventh category of data that may be stored on the data element may comprise data of corresponding (or identical) inserts. This may, for example, comprise details of other inserts comprising tissue models that are the same as the tissue model of the current insert allowing for simulations of medical procedures specifically adapted to a particular tissue model.

A twelfth category of data that may be stored on the data element may comprise planning data. This data may relate to a procedure that is planned to be carried out by a medical practitioner.

As may be apparent to those skilled in the art, the data element may be further configured to allow changes to any of the above data. Moreover, data as above or otherwise may also aid in planning the medical procedure whose simulation may be carried out. In embodiments, some or all of the data listed above, or additions thereto, may also serve to identify the authenticity of the insert, for example, if there is a mismatch between the anatomical data stored for an insert 100 and the apparent anatomy of the physical tissue model 102.

In embodiments, the system 200 may further comprise a data processing means and the above data may instead/also be stored in a section of the data processing means. The data processing means may be further configured to allow access to data stored in it only after successful authentication. It may be further configured to allow access to only a part of the data stored in it based on the ID of the insert 100.

While the above description has only listed some examples of the categories of data that may be stored either on the data element or in a data processing means, it should not be considered restrictive of the present invention and other categories of data may be stored in embodiments.

The assembly 10 comprising the insert 100 and the medical simulation system 200 according to the embodiment depicted in the figures may generally be used to carry out a simulation of a medical procedure typically as follows. The insert 100 may be inserted into the holder assembly 300, by sliding it in the −y-direction, which may be called an insertion direction, and may later be removed from the holder assembly 300 along the y-direction.

The insertion process may involve aligning an outer planar connection surface 121 (that may face downwardly, see, e.g., FIG. 7b) with a base 320 of the holder assembly 300 and a connection portion 120 with a first contact section 3124, 3144 of latching elements 312, 314 of the holder assembly 300. The insert 100 may further be oriented such that its abutment section 126 may be abutted by the stopping element 310 of the holder assembly 300. A pushing force may then be applied on the insert 100 to slide it relative to the base 320 of the holder assembly 300 in the insertion direction.

As the insert 100 is slid into the holder assembly 300, its contact sections 122 enter the grooves formed by the contact sections 3124, 3126 and 3144, 3146. These grooves may serve to guide the insert 100 as it is being pushed parallel to the insertion direction. A blocking element 3127 that may be blocking the path of insertion may now be removed from the insertion path and the insert 100 pushed in further. A releasing element 3129 that may be provided in the holder assembly 300 may also be configured to not block the path of insertion, for example, by expanding it out of the remainder of the holder assembly 300 in the present embodiment.

The contact sections 122 may then encounter a plurality of first latching balls 3128a, 3148a of the holder assembly 300, that may be attached to a spring and that may protrude into the grooves from a second contact section 3126, 3146 of the grooves. The contact sections 122 may be configured such that the first latching balls do not (or do only barely) touch the contact sections in an equilibrium configuration in this state to prevent frictional force from their contact. As the insert 100 is pushed in further, the first latching balls may encounter a plurality of second latching recesses 1222b of the insert 100. The second latching recesses may be made deeper than a maximum protrusion of the first latching balls so that they do not snap into the insert 100 thus preventing further insertion.

Upon further insertion, the first latching balls may be received into a plurality of channels 1224 that may be provided on the contact sections 122. The depth of these channels may also be chosen to allow the first latching balls to pass through them without exerting significant frictional force on the insert 100. Once the insert 100 has been pushed in far enough, the second latching recesses 1222b may encounter a plurality of second latching balls 3128b, 3148b of the holder assembly 300. These second latching balls may be configured to fit into the second latching recesses such that they may lock the insert 100 in-place once they have been received into the second latching recesses.

A plurality of first latching recesses 1222a may also be provided on the contact sections 122 such that when the second latching balls are received in the second latching recesses 1222b, the first latching balls are also received in the first latching recesses 1222a, i.e., the separation between the first and second set of latching balls may be chosen to be the same as the separation between the first and second set of latching recesses. As a result, all four latching balls in the present embodiment, are received into their corresponding latching recesses at the same time, providing a firm locking of the insert 100 into the holder assembly 300. At the same time, the damping elements 3102a, 3102b of the stopping element 310 in the holder assembly 300 may be configured to abut the insert 100 in the insertion direction in an equilibrium configuration.

The blocking element 3127 may now be put back in the path of insertion to block the insert 100 in its place. It may be received into a blocking recess provided on the insert 100. The releasing element 3129 may now be retracted into the remainder of the holder assembly 300 so that a nook of the releasing element 3129 abuts the insert 100 in the insertion direction. A calibration marker 3202 on the base 320 of the holder assembly 300 may also be configured to help locate the position of the holder assembly 300 in in the tracking coordinate frame. This provides localization of the insert in (tracker) space. While there is only one calibration marker 3202 depicted in the Figure, it should be understood that there may in fact be a plurality of calibration markers. This may complete the insertion process of the insert 100 (as shown, for example, in FIGS. 8a-8c).

It may be desirable to have a more realistic simulation of a medical procedure by covering the physical tissue model 102 of the insert 100 with a soft tissue assembly 400. This may be done by connecting a soft tissue holder 410 to the system 200, preferably on the holder assembly 300. A plurality of support holes 3125a, 3125b, 3145a, 3145b may be provided to receive a plurality of legs 4102 of the soft tissue holder 410 to provide this connection.

A soft tissue portion 420 may be allowed to fill the soft tissue holder frame such that it covers the physical tissue model 102 of the insert 100. A skin section (not depicted) may further be attached to the soft tissue holder 410 to cover the soft tissue portion 420. An opaque cover comprising a window may be further connected to the system 200 using the plurality of fixtures 600. The window may be configured to only allow optical and physical access to the skin model.

A simulation of a medical procedure may now be carried out on the physical tissue model 102 of the insert 100, possibly covered with a soft tissue assembly 400 comprising a soft tissue portion 420 and a skin section, preferably after successful authentication of the insert 100 by the system 200, preferably using NFC. Such a simulation may involve applying a force on the physical tissue model of the insert 100, preferably in a direction significantly along the insertion direction. In this case, the damping elements 3102a, 3102b may serve to provide a more realistic haptic feedback.

Data may be accessed from the data element in the insert 100 or from a data processing means provided separately using a reading element in the system 200 to aid in the simulation of a medical procedure. Results from such a simulation, or any other relevant information, may also be stored on the data element or the data processing means and a counter may be updated after a simulation has been carried out.

E.g., after the simulation, the insert 100 may be released from the holder assembly 300. This may be done by removing the blocking element 3127 from the insertion path followed by expanding the releasing element 3129 out of the remainder of the holder assembly 300. This may cause the nook of the releasing element 3129 to push on the insert 100 in a direction opposite to the insertion direction. The push in the opposite direction may in turn push each of the latching balls out of their recesses, releasing the insert 100 from its locked-in position. It may then be released from the holder assembly 300 completely by applying a force opposite to the insertion direction until the outer planer connection surface 121 of the insert 100 is no longer in contact with the base 320 of the holder assembly 300.

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be accidental. That is, unless otherwise specified or unless clear to the skilled person, the order in which steps are recited may be accidental. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

While in the above, a preferred embodiment has been described with reference to the accompanying drawings, the skilled person will understand that this embodiment was provided for illustrative purpose only and should by no means be construed to limit the scope of the present invention, which is defined by the claims.

1. An insert for a medical simulation system, wherein the insert is configured to be releasably connected to the system, comprising: a connection portion configured to provide the releasable connection to the system, and at least one latching recess, wherein each of the at least one latching recess is configured to receive a latching device of a connection section of the system.

2. The insert according to claim 1, wherein the insert is configured to be inserted into the system in an insertion direction,
wherein the insert comprises an outer planar connection surface and at least one channel;
wherein the at least one latching recess is a plurality of latching recesses, wherein a plurality of latching recesses, form a first set of latching recesses, and wherein a plurality of latching recesses form a second set of latching recesses,
and wherein the connection portion comprises a plurality of contact sections, wherein each contact section comprises a planar outer contact surface, wherein each planar contact surface is at an angle to the outer planar connection surface,
and wherein a first contact section comprises the first set of latching recesses, and
wherein a second contact section comprises the second set of latching recesses,
wherein each set of latching recesses comprises, a first latching recess and a second latching recess, wherein the first latching recess extends inwardly from the planar outer contact surface of the contact section, and the second latching recess extends inwardly from a surface, which is set back from the planar outer contact surface of the contact section,
wherein the second latching recess of each set is more forward in the insertion direction than the first latching recess of each set,
and wherein each contact section comprises at least one channel, between the first latching recess and the second latching recess of each set, configured to be parallel to the insertion direction, further configured to be at least as deep as the first latching recess.

3. The insert according to claim 1, wherein the insert is configured to be inserted into a holder assembly of the system in an insertion direction, comprising: at least one blocking recess configured to receive at least one blocking element of the holder assembly, the insert further comprising: at least one abutment section for abutting at least one abutment mechanism of the holder assembly, wherein the at least one abutment section is located at a forward end of the insert in the insertion direction.

4. The insert according to claim 1, wherein the insert comprises a tissue model portion.

5. The insert according to claim 1, wherein the insert comprises a data element configured to at least store data that can be read out, wherein the data element comprises an ID, and wherein the data element further comprises a key, wherein the key is a diversified key obtained by using the ID of the data element and a master key.

6. The insert according to claim 5, wherein the data element is an NFC tag embedded in the remainder of the insert, or located on an outer surface of the insert.

7. A medical simulation system, wherein the system is configured to releasably receive an insert, wherein the system comprises a holder assembly configured to provide the releasable connection to the insert, the holder assembly comprising: at least one stopping element, at least one latching element, and at least one latching device.

8. The system according to claim 7, wherein the system is configured to receive the insert in an insertion direction,
wherein the at least one stopping element comprises at least one planar surface and wherein the at least one stopping element comprises at least one damping element comprising an outer contact surface, wherein the outer contact surface is configured to abut an insert when the insert is received in the holder assembly, and wherein each of the at least one damping element is configured to have an equilibrium configuration, wherein it is further configured to apply a force in order to return to its equilibrium configuration, wherein the equilibrium configuration comprises the outer contact surface of each of the at least one damping element protruding beyond the planar surface of the stopping element in a direction opposite to the insertion direction,
and wherein each of the at least one latching element is parallel to the insertion direction and comprises a groove comprising a plurality of contact sections and a basal planar surface, wherein each contact section comprises a planar contact surface, wherein the planar contact surface of a first contact section is orthogonal to the basal planar surface, and wherein the planar contact surface of a second contact section is at an angle to the planar contact surface of the first contact section,
and wherein each of the at least one latching device is configured to have an equilibrium configuration and wherein it is further configured to apply a force in order to return to its equilibrium configuration, wherein the equilibrium configuration comprises each of the at least one latching device protruding into the groove from the planar contact surface of the second contact section,
and wherein each of the at least one latching device is a plurality of latching devices, wherein a plurality of latching devices form a first set of latching devices, and wherein a plurality of latching devices form a second set of latching devices, wherein the first set of latching devices comprises a first latching device and a second latching device, wherein the second latching device in the first set of latching devices is more forward in the insertion direction than the first latching device, and wherein the second set of latching devices comprises a first latching device and a second latching device wherein the second latching device in the second set of latching devices is more forward in the insertion direction than the first latching device.

9. The system according to claim 7, wherein the system is configured to releasably receive an insert in an insertion direction, wherein the system comprises a holder assembly configured to provide the releasable connection to the insert, the holder assembly comprising: at least one blocking element configured to block the holder assembly from receiving or releasing the insert, further configured to be immovable parallel to the insertion direction, the holder assembly further comprising: at least one releasing element configured to at least apply a force opposite to the insertion direction, the holder assembly further comprising: at least one calibration marker configured to enable determination of the position and/or orientation of the holder assembly in space.

10. The system according to claim 7, further comprising a soft tissue assembly configured to cover, at least in part, the insert, the soft tissue assembly further comprising: a soft tissue holder comprising at least one leg, the soft tissue holder further comprising a support frame, the soft tissue assembly further comprising a soft tissue portion, and a skin section, and wherein the holder assembly further comprises at least one support hole configured to receive the at least one leg of the soft tissue holder.

11. The system according to claim 7, wherein the system further comprises a data processing means configured to at least store data, wherein the data processing means is further configured to effect changes of the data stored in it, wherein it is further configured to allow access to at least a part of the data stored in it based on a key, wherein the key is a diversified key.

12. The system according to claim 7, wherein the system is configured to releasably receive the insert, and the system comprises a holder assembly and a reading element, wherein the holder assembly is configured to provide the releasable connection to the insert, the holder assembly comprising: at least one stopping element, at least one latching element, and at least one latching device, and the reading element is configured to read and/or change data stored on a data element, wherein the reading element is configured to be used together with an insert according to claim 6, wherein the system comprises the master key.

13. The system according to claim 12, wherein the reading element is an NFC reader.

14. An assembly comprising the medical system according to claim 1, wherein:
the medical system is configured to releasably receive the insert, and the system comprises a holder assembly configured to provide the releasable connection to the insert, the holder assembly comprising: at least one stopping element, at least one latching element, and at least one latching device.

15. A method for using an assembly comprising the medical simulation system according to claim 6, wherein the system is configured to releasably receive the insert, wherein the system comprises a holder assembly and a releasing element, wherein the holder assembly is configured to provide the releasable connection to the insert, the holder assembly comprising: at least one stopping element, at least one latching element, and at least one latching device, and the reading element is configured to read and/or change data stored on a data element, wherein the reading element is configured to be used together with the insert, wherein the system comprises the master key, wherein the master key is preferably stored in a secure section of the system, wherein the method comprises:
reading, by the reading element, data stored on the data element, authenticating the data element comprising: the system re-generating the diversified key by means of the master key and the ID, using the re-generated diversified key and the diversified key on the insert for verification, allowing a medical simulation only when the re-generated diversified key matches with the diversified key on the insert, wherein the method further comprises reading and/or changing at least part of the data stored in the data element, the method further comprising changing a counter on the data element when a simulation procedure is detected to have been carried out, wherein the counter is configured to have a preset value and is not allowed to change in value after the preset value is reached, wherein the method further comprises reading and/or changing additional data on the data element such as any of anatomical data, physiological data, labelling data, medical imaging data, treatment data, model usage data, spatial mapping data, physical model data, logistical data, planning data or any other data.

16. A method comprising using an assembly comprising the medical simulation system according to claim 5 wherein the system is configured to releasably receive the insert, wherein the system comprises a holder assembly and a releasing element, wherein the holder assembly is configured to provide the releasable connection to the insert, the holder assembly comprising: at least one stopping element, at least one latching element, and at least one latching device, and the reading element is configured to read and/or change data stored on a data element, wherein the reading element is configured to be used together with the insert, wherein the system comprises the master key, wherein the master key is preferably stored in a secure section of the system, wherein the method comprises:
reading, by the reading element, data stored on the data element, authenticating the data element comprising: the system re-generating the diversified key by means of the master key and the ID, using the re-generated diversified key and the diversified key on the insert for verification, allowing a medical simulation only when the re-generated diversified key matches with the diversified key on the insert, the method further comprising reading and/or changing at least part of the data stored in the data processing means, the method further comprising changing a counter on the data processing means when a simulation procedure is detected to have been carried out, wherein the counter is configured to have a preset value and is not allowed to change in value after the preset value is reached, wherein the method further comprises reading and/or changing additional data in the data processing means such as any of anatomical data, physiological data, labelling data, medical imaging data, treatment data, model usage data, spatial mapping data, physical model data, logistical data, or any other data.

17. The system according to claim 8, wherein the planar surface is orthogonal to the insertion direction.

18. The system according to claim 12, wherein the master key is preferably stored in a secure section of the system.
